(19) United States
(12) Patent Application Publication
(10) Pub. No.: US 2011/0134872 A1
(43) Pub. Date: Jun. 9, 2011

(54) BASE STATION AND TERMINAL

(75) Inventors: Seigo Nakao, Kanagawa (JP); Masayuki Hoshino, Kanagawa (JP)

(73) Assignee: PANASONIC CORPORATION, Osaka (JP)

(21) Appl. No.: 13/057,435

(22) PCT Filed: Aug. 7, 2009
(86) PCT No.: PCT/JP2009/003800

§ 371 Date: Feb. 3, 2011

(51) Int. Cl. H04W 72/04

(52) U.S. Cl. 370/329

(57) ABSTRACT

Disclosed are a base station and a terminal which implement wideband uplink data communication as well as implementing a placement method for control channels (CCHs) in a frame, which can be used by terminals having various terminal capabilities. In a base station (200), a control unit (270) selects a configuration pattern for an uplink subframe consisting of two slots from a first pattern in which CCHs are placed on both edges of each unit band and the CCHs placed on both edges of each unit band change places between slots, and a second pattern in which each channel block including a plurality of CCHs is placed on both edges of an expanded band consisting of a plurality of unit bands and the frequency positions of the constituent control channels in each channel block change places between slots. A terminal to be allocated forms an uplink signal in which the response signal is mapped to the frequency position of the CCH according to the configuration pattern information of the subframe.

### TECHNICAL FIELD

The present invention relates to a base station and terminal.

### Background Art

In 3GPP-LTE, an SC-FEMA (Single-Carrier Frequency Division Multiple Access) is adopted as an uplink communication scheme (see Non-Patent Literature 1). With SC-FDMA, N symbols modulated by a predetermined modulation scheme (e.g. QPSK) on the time axis are separated in a plurality of frequency components, mapped on subcarriers that differ between frequency components and, after being changed back to a time domain waveform, attached a CP (Cyclic Prefix), thereby forming an SC-FDMA symbol. That is, one SC-FDMA symbol includes N time continuous signals and CP.

Also, in 3GPP-LTE, a radio communication base station apparatus (which may be simply referred to as “base station” below) allocates resources for uplink data to a radio communication terminal apparatus (which may be simply referred to as “terminal” below) via a physical channel (e.g. PUCCH (Physical Downlink Control CHannel)).

Upon receiving information about allocation of resources for uplink data, the terminal transmits data stored in its buffer to the base station using these resources.

Also, in 3GPP-LTE, ARQ (Automatic Repeat reQuest) is applied to downlink data from a base station to a terminal. That is, the terminal feeds back a response signal indicating the error detection result of downlink data to the base station. The terminal performs CRC (Cyclic Redundancy Check) check of downlink data and feeds back an ACK (ACKnowledgment) when CRC=OK (no error) or feeds back a NACK (Negative ACKnowledgment) when CRC=NG (error present), to the base station, as a response signal. A PUCCH (Physical Uplink Control CHannel) is used for feedback of this response signal (i.e. ACK/NACK signal).

FIG. 1 shows allocation of PUCCH resources in a case where the system bandwidth is 20 MHz in a 3GPP LTE system (which may be referred to as “LTE system” below). PUSCH's (Physical Uplink Shared CHannels) shown in FIG. 1 are used for uplink data transmission of a terminal.

As shown in FIG. 1, time is divided in subframe units in the 3GPP LTE system. Each subframe has two slots. One slot includes seven SC-FDMA symbols. Also, PUCCH's are placed at both edges of the system band (specifically, resource blocks (RB's) at both edges of the system band). The PUCCH's placed at both edges of the system band are switched between slots, that is, subjected to frequency hopping every slot.

For example, when PUCCH1 in FIG. 1 is assigned, a terminal supporting the 3GPP LTE system (which may be referred to as “LTE terminal” below) maps control channel signals such as response signals on PUCCH 1 placed in a system band edge part that switches between slots. At this time, the control channel signals are mapped to continue over the boundary between two slots included in the same subframe in the time domain.

To map a control channel signal in this way, the LTE terminal matches the center frequency of the transmission band (i.e. RF transmission frequency) of that terminal to the center frequency of the 20 MHz system band, and generates a control channel signal in a digital manner using an IFFT circuit that can support the whole 20 MHz band. To be more specific, in the IFFT circuit of the LTE terminal, a control channel signal is received as input only in RB's having frequency in the upper end of the system band, and 0 is received as input in other frequency components, in the first slot in a certain subframe. Also, in the IFFT circuit of the LTE terminal, a control channel signal is received as input only in RB's having frequency in the lower end of the system band, and 0 is received as in the other frequency components, in the second slot in the same subframe. Thus, a terminal having an RF circuit supporting a 20 MHz bandwidth can continuously generate control channel signals with frequency hopping.

Also, standardization of 3GPP LTE-advanced, which realizes faster communication than 3GPP LTE, has been started (see Non-Patent Literature 2). The 3GPP LTE-advanced system (which may be referred to as “LTE+ system” below) follows the 3GPP LTE system. In 3GPP LTE-advanced, to realize downlink transmission speed equal to or greater than maximum 1 Gbps, it is expected to adopt a base station and terminal that can perform communication in a wideband frequency equal to or greater than 20 MHz. Here, to prevent unnecessary complication of the terminal, the terminal side is expected to define the terminal capability related to frequency band support. The terminal capability defines that, for example, the minimum value of a support bandwidth is 20 MHz.

That is, a base station supporting the LTE+ system (which may be referred to as “LTE+ base station” below) is formed to be able to perform communication in a frequency band including a plurality of “unit bands.”

Here, a “unit band” in downlink is a band of a maximum 20 MHz range, including SCH (Synchronization CHannel) near the center, and is defined as a reference unit of a communication band. Further, the unit band is defined as a band separated by downlink frequency band information in a BCH (Broadcast CHannel) broadcasted from the base station, or as a band defined by a distribution width in a case of allocating PDCCH's in a distributed manner. Here, a “unit band” in uplink is a band separated by uplink frequency band information in the BCH broadcasted from the base station, or defined as a frequency reference unit equal to or less than 20 MHz which includes a PUSCH near the center and includes PUCCH's in the both edges. To be more specific, an LTE terminal can receive only one “unit band” at a time and transmit one “unit band” at a time. Also, a “unit band” may be expressed as “component carrier(s)” in English in 3GPP LTE-advanced.

An LTE+ base station needs to support not only the above LTE terminal but also an LTE+ system support terminal (which may be referred to as “LTE+ terminal” below). Also, the LTE+ system support terminal (which may be referred to as “LTE+ terminal” below) includes a terminal that can have only one unit band in the communication-capable bandwidth as a unit band, and a terminal that can have a plurality of unit bands in the communication-capable bandwidth.

That is, actually, an integration communication system including the LTE system in which single communication is independently assigned every unit band and the LTE+ system which follows the LTE system and in which a plurality of unit bands can be assigned in single communication.

### CITATION LIST

### Non-Patent Literature

[NPL]
3GPP TS 36.211 V8.3.0, “Physical Channels and Modulation (Release 8),” May 2008
[NPL 2]
3GPP TR 36.913 V8.0.0, “Requirements for Further Advancements for E-UTRA (LTE-Advanced) (Release 8),” June 2008

### SUMMARY OF INVENTION

### Technical Problem

In the above integration system, an LTE terminal and LTE+ terminal need to transmit a control channel signal to a base station.

Here, FIG. 2 shows a method of allocating PUCCH resources in a ease where the bandwidth of unit bands is 20 MHz and the uplink system band is 40 MHz.

In FIG. 2, the uplink system band is divided into two unit bands of 20 MHz, and the PUCCH in each unit band is subjected to frequency hopping. That is, terminals are divided into two groups, and terminals belonging to one group transmit a response signal in the unit band on the higher frequency side, and terminals belonging to the other group transmit a response signal in the unit band on the lower frequency side. By this means, it is possible to provide at the same time an LTE terminal and LTE+terminal that support only 20 MHz and an LTE+ terminal that supports 40 MHz, and secure PUCCH's for response signal transmission.

However, with the resource allocation method shown in FIG. 2, the 40 MHz uplink system band is separated by PUCCH's. That is, PUSCH's are separated by PUCCH's. Therefore, it is not possible to apply an SC-FDMA scheme for transmitting a signal only in consecutive bands, to two separated PUSCH's. Therefore, even a terminal that can support 40 MHz cannot provide a transmission rate based on the terminal capability.

It is therefore an object of the present invention to provide a base station and terminal that can realize uplink data communication in a wideband while realizing a method of placing a control channel in a frame, which can be used by terminals having various terminal capabilities.

### Solution to Problem

The base station of the present invention that assigns a plurality of unit bands to single communication, employs a configuration having: a selecting section that selects a formation pattern of an uplink subframe formed with two slots, between a first pattern in which control channels are placed at both edges of each unit band and in which the control channels placed at both edges of the each unit band are switched between slots, and a second pattern in which channel blocks including a plurality of control channels are placed at both edges of an enhancement band formed with a plurality of unit bands and in which frequency positions of constituent control channels in each control channel block are switched between slots; and a transmission section that transmits information related to the selected formation pattern to an assignment target terminal to which the uplink subframe is assigned.

The terminal of the present invention that transmits a single carrier frequency division multiple access symbol in an uplink subframe, which is assigned by a base station that can assign a plurality of unit bands to single communication and which is formed with two slots, employs a configuration having: an obtaining section that obtains pattern information to indicate whether a formation pattern of the assigned uplink subframe is a first pattern, in which control channels are placed at both edges of each unit band and the control channels placed at both edges of each unit band are switched between slots, or the formation pattern is a second pattern in which channel blocks including a plurality of control channels are placed at both edges of an enhancement band formed with a plurality of unit bands and in which frequency positions of constituent control channels in each control channel block are switched between slots; a transmission section that is configure to be able to change a transmission band and transmits the single carrier frequency division multiple access symbol; a forming section that forms the single carrier frequency division multiple access symbol, comprising a mapping section that maps a control channel signal on a frequency position based on the pattern information in the single carrier frequency division multiple access symbol, and a precoding section that performs precoding of a signal obtained in the mapping section by a weighted vector; and a control section that, when the obtained pattern information indicates the second pattern and a reference bandwidth in a formation pattern based on the pattern information is larger than a communication-capable bandwidth of the terminal, matches the transmission band to one end of the enhancement band and changes a frequency position on which the control channel signal is mapped in a channel block placed at the one end, and the weighted vector between a first slot and a second slot.

The terminal of the present invention that transmits a single carrier frequency division multiple access symbol in an uplink subframe, which is assigned by a base station that can assign a plurality of unit bands to single communication and which is formed with two slots, employs a configuration having: an obtaining section that obtains pattern information to indicate whether a formation pattern of the assigned uplink subframe is a first pattern, in which control channels are placed at both edges of each unit band and the control channels placed at both edges of each unit band are switched between slots, or the formation pattern is a second pattern in which channel blocks including a plurality of control channels are placed at both edges of an enhancement band formed with a plurality of unit bands and in which frequency positions of constituent control channels in each control channel block are switched between slots; a transmission section that is configure to be able to change a transmission band and transmits the single carrier frequency division multiple access symbol; a forming section that forms the single carrier frequency division multiple access symbol, comprising a mapping section that maps a control channel signal on a frequency position based on the pattern information in the single carrier frequency division multiple access symbol; and a control section that, when the obtained pattern information indicates the second pattern and a reference bandwidth in a formation pattern based on the pattern information is larger than a communication-capable bandwidth of the terminal, matches the transmission band to one end of the enhancement band and changes a frequency position on which the control channel signal is mapped in a channel block placed at the one end, and an output destination antenna of the transmission section between a first slot and a second slot.

### Advantageous Effects of Invention

According to the present invention, it is possible to provide a base station and terminal that can realize uplink data communication in a wideband while realizing a method of placing control channels in a frame, which can be used by terminals having various terminal capabilities.

### BRIEF DESCRIPTION OF DRAWINGS

FIG. 1 shows allocation of PUCCH resources in a case where the system bandwidth is 20 MHz in a 3GPP LTE system;

FIG. 2 shows an allocation method of PUCCH resources (related art) in a case where the bandwidth of unit bands is 20 MHz and the uplink system bandwidth is 40 MHz;

FIG. 3 is a block diagram showing a configuration of a terminal according to Embodiment 1 of the present invention;

FIG. 4 is a block diagram showing a configuration of a base station according to Embodiment 1 of the present invention;

FIG. 5 shows an uplink frame condition based on scheduling of subframe formation patterns in a base station;

FIG. 6 illustrates transmission operations of a response signal in a terminal in a case where the communication-capable bandwidth of the subject terminal is smaller than the reference bandwidth of the second pattern;

FIG. 7 is a block diagram showing a configuration of a terminal according to Embodiment 2 of the present invention;

FIG. 8 shows an uplink frame condition based no scheduling of subframe formation patterns in a base station;

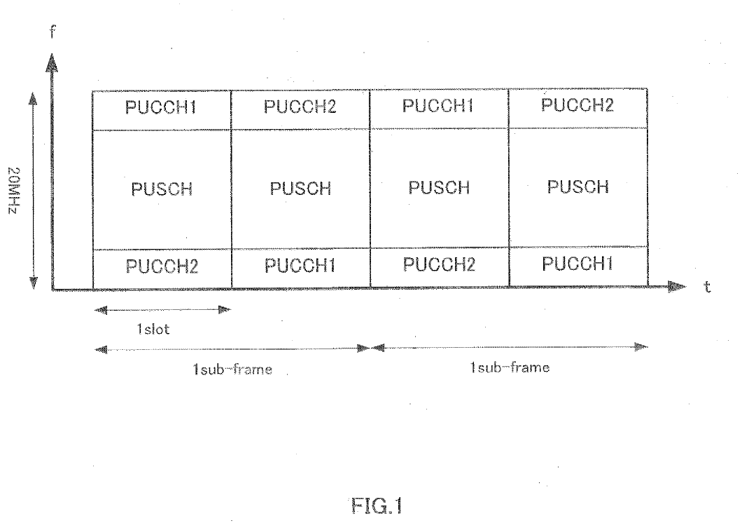

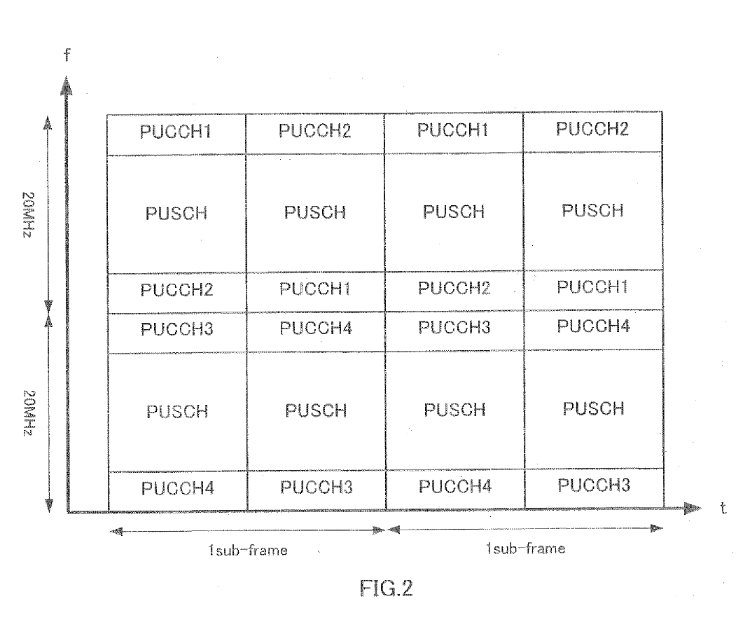

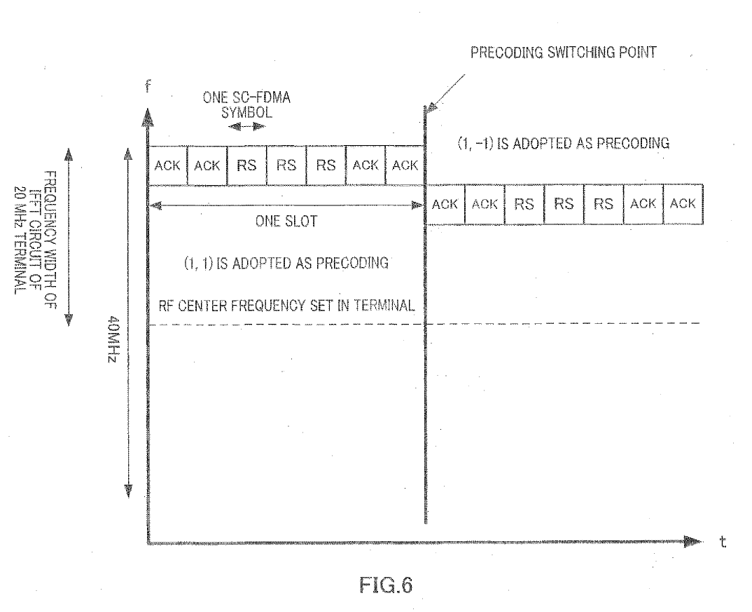

FIG. 6 illustrates transmission operations of a response signal in a terminal in a case where the communication-capable bandwidth of the subject terminal is smaller than the reference bandwidth of the second pattern;

FIG. 10 is a block diagram showing a configuration of a terminal according to Embodiment 3 of the present invention;

FIG. 11 is a block diagram showing a configuration of a base station according to Embodiment 3 of the present invention;

FIG. 12 shows an uplink frame condition based on scheduling of subframe formation patterns in a base station;

FIG. 13 illustrates transmission operations of a response signal in a terminal in a case where the communication-capable bandwidth of the subject terminal is smaller than the reference bandwidth of the second pattern;

FIG. 14 illustrates transmission operations of a response signal in a terminal in a case where the communication-capable bandwidth and the reference bandwidth of the second pattern are equal;

FIG. 15 is a block diagram showing a configuration of a terminal according to Embodiment 4 of the present invention; and

FIG. 16 illustrates transmission operations of a response signal in a terminal in a case where the communication-capable bandwidth of the subject terminal is smaller than the reference bandwidth of the second pattern.

### DESCRIPTION OF EMBODIMENT

Now, embodiments of the present invention will be explained in detail with reference to the accompanying drawings. Also, in embodiments, the same components will be assigned the same reference numerals and their overlapping explanation will be omitted.

### Embodiment 1

### [Terminal Configuration]

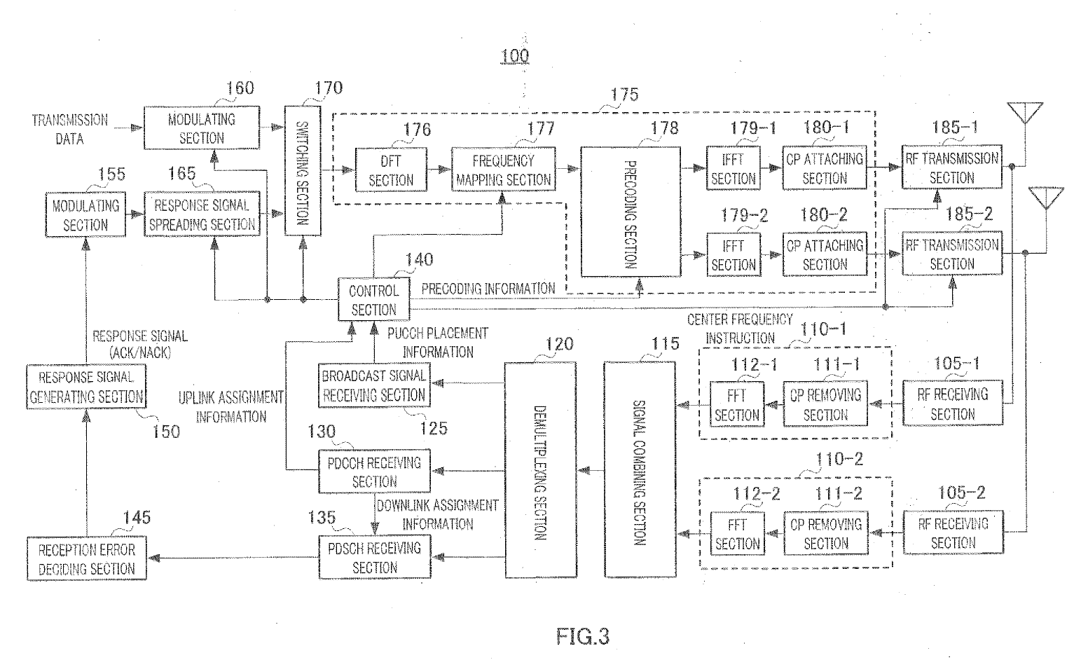

FIG. 3 is a block diagram showing a configuration of terminal 100 according to Embodiment 1 of the present invention. In FIG. 3, terminal 100 is provided with RF receiving sections 105, OFDM signal demodulating sections 110, signal combining section 115, demultiplexing section 120, broadcast signal receiving section 125, PDCCH receiving section 130, PDSCH (Physical Downlink Shared CHannel) receiving section 135, control section 140, reception error deciding section 145, response signal generating section 150, modulating section 155, modulating section 160, response signal spreading section 165, switching section 170, SC-FDMA (Single-Carrier Frequency Division Multiple Access) signal forming section 175 and RF transmission sections 185. Terminal 100 has two antennas, and therefore two RF receiving sections 105, two OFDM signal demodulating sections 110 and two RF transmission sections 185. That is, terminal 100 has two RF transmission sections 185, and therefore two power amplifiers (PA's).

RF receiving sections 105 perform radio reception processing (such as down-conversion and analog-to-digital (A/D) conversion) on radio reception signals received via antennas, and output the resulting reception signals to OFDM signal demodulating sections 110.

OFDM signal demodulating sections 110 have CP (Cyclic Prefix) removing sections 111-1 and 111-2 and fast Fourier transform (FFT) sections 112-1 and 112-2. OFDM signal demodulating sections 110 receive the reception OFDM signals from RF receiving sections 105-1 and 105-2, respectively. In OFDM signal demodulating sections 110, CP removing sections 111-1 and 111-2 remove a CP from the reception OFDM signals, and FFT sections 112-1 and 112-2 transform the reception OFDM signals without a CP into frequency domain signals, respectively. These frequency domain signals are outputted to signal combining section 115.

Signal combining section 115 combines the frequency domain signals obtained in FFT sections 112-1 and 112-2 on a per frequency component basis.

Demultiplexing section 120 demultiplexes the frequency domain signal received from signal combining section 115 into the broadcast signal, control signal (i.e. PDCCH signal) and data signal (i.e. PDSCH signal) included in that frequency domain signal. The broadcast signal is outputted to broadcast signal is outputted to broadcast signal receiving section 125, the PDCCH signal is outputted to PDCCH receiving section 130, and the PDSCH signal is outputted to PDSCH receiving section 135.

Broadcast signal receiving section 125 extracts PUCCH placement information included in the broadcast signal received from demultiplexing section 120, and outputs the extracted PUCCH placement information to control section 140.

PUCCH receiving section 130 extracts uplink assignment information and downlink assignment information included in the control signal received from demultiplexing section 120, outputs the obtained uplink assignment information to control section 140 and outputs the obtained downlink assignment information to PDSCH receiving section 135.

PDSCH receiving section 135 extracts a downlink data signal for the subject terminal based on the downlink assignment information (i.e. information about a frequency position on which the downlink data signal for that terminal is mapped) received from PDCCH receiving section 130, performs reception processing (such as demodulation processing and decoding processing) on the obtained data signal and outputs the decoding result to reception error deciding section 145.

Control section 140 controls a weighted vector used for precoding and a frequency position and transmission band on which a response signal is mapped in an SC-FDMA signal, based on the uplink assignment information received from PDCCH receiving section 130 and the PUCCH placement information received from broadcast signal receiving section 125. Here, the PUCCH placement information includes formation pattern information of uplink subframes. The uplink subframe formation patterns include: the first pattern in which control channels are placed at both edges of each unit band and the control channels placed at both edges of each unit band are switched between slots; and the second pattern in which channel blocks including a plurality of control channels are placed at both edges of an enhancement band formed with a plurality of unit bands and in which the frequency positions of the constituent control channels in each control channel block are switched between slots. In the first pattern, the unit bandwidth is a “reference bandwidth,” and, in the second pattern, the enhancement bandwidth is the reference bandwidth.

To be more specific, control section 140 decides whether the uplink subframe formation pattern assigned to the subject terminal is the first pattern or the second pattern.

Then, control section 140 outputs, to SC-FDMA signal forming section 175, a mapping control signal for mapping a PUCCH signal (i.e. response signal) on a frequency position based on the uplink subframe formation pattern. Here, in the case of the above first pattern, in the first slot of the same subframe, control section 140 maps a response signal on one end of the IFFT frequency band in SC-FDMA signal forming section 175 and maps a response signal on the other end in the second slot. In contrast, in the case of the second pattern, control section 140 maps a response signal on one end of the IFFT frequency band in SC-FDMA signal forming section 175 in the first and second slots of the same subframe. Here, in the second pattern, the frequency positions of control channels in channel blocks placed at the one end are switched between the first slot and the second slot. Therefore, for SC-FDMA signal forming section 175, control section 140 maps a PUCCH signal on the frequency positions corresponding to control channels assigned to the subject terminal in channel blocks placed at the one end.

Also, if the second pattern is decided, control section 140 switches weighted vectors used in SC-FDMA signal forming section 175 between the first slot and the second slot in the same subframe, according to precoding information.

Also, if the second pattern is decided, the communication-capable bandwidth (i.e. bandwidth determined by terminal capability) of the subject terminal and the reference bandwidth in the second pattern are compared.

As a result of comparison, if the reference bandwidth in the second pattern is smaller than the communication-capable bandwidth of the subject terminal or these bandwidths are equal, control section 140 uses a spreading code used in response signal spreading section 165 as a spreading code for a normal format. At this time, control section 140 adjusts the transmission band of RF transmission section 185 to the enhancement band.

In contrast, as a result of comparison, if the communication-capable bandwidth of the subject terminal is smaller than the reference bandwidth in the second pattern, control section 140 adjusts the transmission band of RF transmission section 185 to one end of the enhancement band in which control channels assigned to the subject terminal are placed. This transmission band adjustment is performed based on a center frequency instruction outputted from control section 140.

At this time, control section 140 also uses a spreading code used in response signal spreading section 165 as a spreading code for the normal format.

Reception error deciding section 145 decides whether decoding succeeds or fails, by CRC check, and outputs the result to response signal generating section 150.

Response signal generating section 150 generates a response signal (ACK/NACK) based on a signal, which is received from reception error deciding section 145 and which indicates whether decoding succeeds or fails, and outputs the signal to modulating section 155.

Modulating section 155 modulates the response signal received from response signal generating section 150 in a predetermined modulation Scheme (such as BPSK and QPSK) and outputs the modulated response signal to response signal spreading section 165.

Modulating section 160 modulates input transmission data based on an instruction from control section 140, and outputs the resulting modulated data signal to switching section 170.

Response signal spreading section 165 spreads the modulated response signal using a spreading code based on the instruction from control section 140, and outputs the spread response signal to switching section 170.

Switching section 170 selects one of the modulated data signal and spread response signal, and outputs the selected signal to SC-FDMA signal forming section 175.

SC-FDMA signal forming section 175 forms an SC-FDMA signal in which the output signal of switching section 170 is mapped on a frequency position based on the instruction from control section 140, and outputs the formed signal to RF transmission sections 185. SC-FDMA signal forming section 175 is provided with DFT section 176, frequency mapping section 177, precoding section 18, IFFT sections 179-1 and 179-2 and CP attaching sections 180-1 and 180-2.

In SC-FDMA signal forming section 175, DFT section 176 divides an input signal into a plurality of frequency components. Then, frequency mapping section 177 maps the signals obtained in DFT section 176 on frequency positions based on an instruction from control section 140.

After that, precoding section 178 applies precoding processing based on precoding information to frequency domain signals in which a response signal is mapped on predetermined frequency positions in frequency mapping section 177.

To be more specific, precoding section 178 precodes a frequency domain signal placed in the first slot of the same subframe, by the first weighted vector. That is, precoding section 178 outputs to IFFT section 179-1 a frequency domain signal weighted by the first element of the first weighted vector, and outputs to IFFT section 179-2 a frequency domain signal weighted by a second element of the first weighted vector. Also, precoding section 178 precodes a frequency domain signal placed in the second slot of the same subframe, by a second weighted vector orthogonal to the first weighted vector. Precoding section 178 outputs to IFFT section 179-2 a frequency domain signal weighted by the first element of a second weighted vector, and outputs to IFFT section 179-2 a frequency domain signal weighted by a second element of the second weighted vector.

Thus, it is possible to transmit response signals subjected to space hopping.

Then, after IFFT section 179-1 (IFFT section 179-2) returns the signal obtained in precoding section 178 to a time domain waveform, CP attaching section 180-1 (CP attaching section 180-2) attaches a CP (Cyclic Prefix).

RF transmission section 185 is formed to be able to change the transmission band. RF transmission section 185 receives a center frequency instruction from control section 140 and moves the transmission band by moving the RF center frequency based on the center frequency instruction. RF transmission section 185-1 performs radio transmission processing of an SC-FDMA signal received from CP attaching section 180-1, and transmits the result via the first antenna. RF transmission section 185-2 performs radio transmission processing of an SC-TDMA signal received from CP attaching section 180-2, and transmits the result via a second antenna. Here, although the center frequency of a transmission band is used as a reference frequency, it is equally possible to use an arbitrary frequency included in the transmission band as the reference frequency.

[Base Station Configuration]

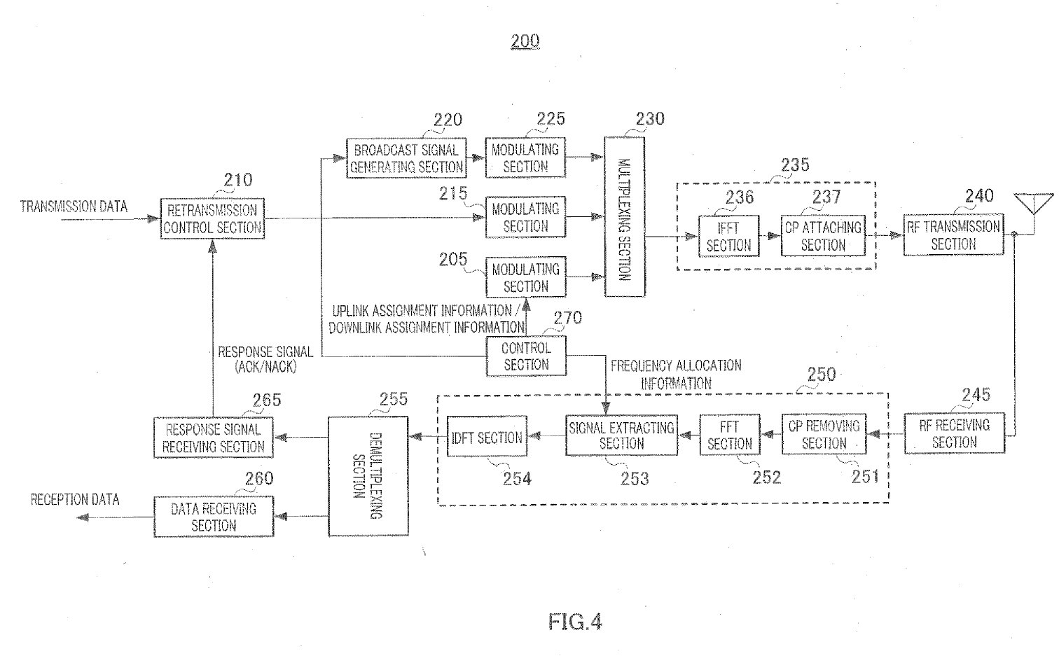

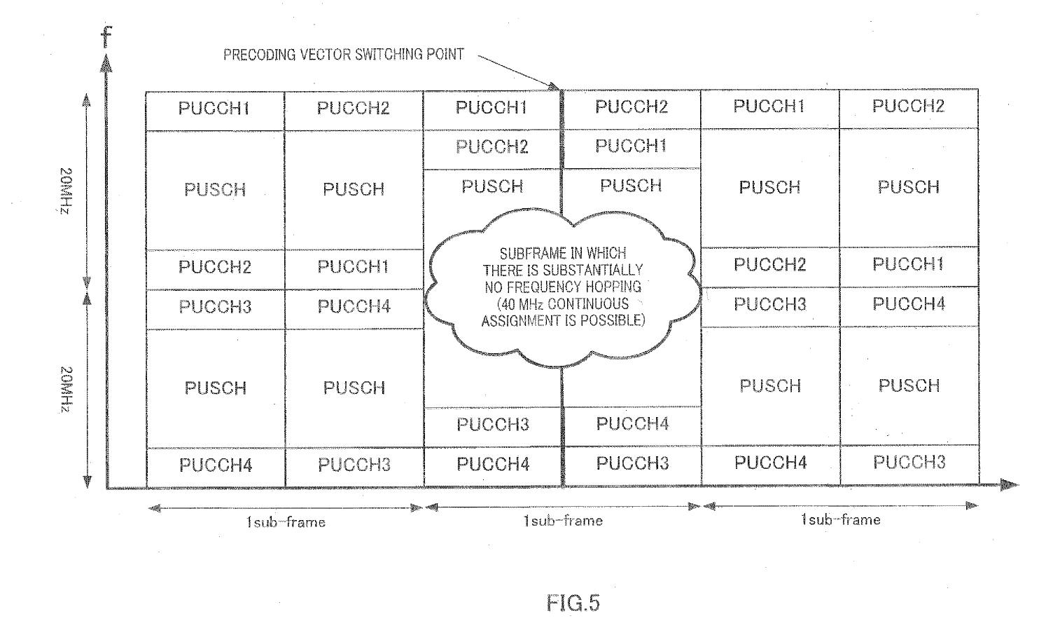

FIG. 4 is a block diagram showing a configuration of base station 200 according to Embodiment 1 of the present invention. In FIG. 4, base station 200 is provided with modulating section 205, retransmission control section 210, modulating section 215, broadcast signal generating section 220, modulating section 225, multiplexing section 230, OFDM signal forming section 235, RF transmission section 240, RF receiving section 245, SC-FDMA signal demodulating section 250, demultiplexing section 255, data receiving section 260, response signal receiving section 265 and control section 270.

Modulating section 205 modulates uplink assignment information and downlink assignment information received from control section 270, and outputs the modulation signals to multiplexing section 230.

Retransmission control section 210 receives new transmission data as input, holds the new transmission data and outputs an ACK signal related to the previous transmission data, to modulating section 215 as a trigger. Also, upon receiving a NACK signal from response signal receiving section 265, retransmission control section 210 outputs the held transmission data to modulating section 215 for retransmission.

Modulating section 215 modulates the transmission data received from retransmission control section 210 and outputs the modulation signal to multiplexing section 230.

Broadcast signal generating section 220 generates a broadcast signal including information indicating a formation pattern selected in control section 270, and outputs this broadcast signal to modulating section 225.

Modulating section 225 modulates the broadcast signal received from broadcast signal generating section 220 and outputs the modulation signal to multiplexing section 230.

Multiplexing section 230 time-multiplexes or frequency-multiplexes the modulation signal of transmission data received from modulating section 215, the modulation signals of uplink assignment information and downlink assignment information received from modulating section 205 and the modulation signal of broadcast signal received from modulating section 225. At this time, the modulation signal of transmission data is placed in resources corresponding to a PDSCH. Also, the modulation signals of uplink assignment information and downlink assignment information are placed in resources corresponding to a PDCCH. Further, the modulation signal of broadcast signal is placed in resources corresponding to a BCH (Broadcast CHannel).

In OFDM signal forming section 235, IFFT section 236 obtains a time domain wave by performing serial-to-parallel conversion and then performing an IFFT of the multiplex signal formed in multiplexing section 230. By attaching a CP to this time domain waveform in CP attaching section 237, the OFDM signal is provided.

RF transmission section 240 performs radio transmission processing on the OFDM signal formed in OFDM signal forming section 235 and transmits the result via an antenna.

RF receiving section 245 performs radio reception processing (such as down-conversion and analog-to-digital (A/D) conversion) on a radio reception signal received via the antenna, and outputs the resulting reception signal to SC-FDMA signal demodulating section 250.

SC-FDMA signal demodulating section 250 demodulates the reception SC-FDMA signal received from RF receiving section 245. To be more specific, CP removing section 251 removes a CP from the reception SC-FDMA signal, and FFT section 252 transforms the reception SC-FDMA signal without a CP into a frequency domain signal. Then, signal extracting section 253 extracts a frequency component corresponding to frequency assignment information received from control section 270, from the frequency domain signal, and IDFT section 254 transforms the extracted frequency component into a single carrier signal on the time axis.

Demultiplexing section 255 demultiplexes the single carrier signal received from SC-FDMA signal demodulating section 250 into the reception data signal and response signal, outputs the reception data signal to data receiving section 260 and outputs the response signal to response signal receiving section 265.

Data receiving section 260 decodes the reception data signal received from demultiplexing section 255 and transfers the resulting decoded data to a higher layer such as MAC.

First, response signal receiving section 265 extracts a response signal transmitted from terminal 100 by applying despreading processing associated with spreading processing in response signal spreading section 165 of terminal 100, to the response signal received from demultiplexing section 255. Further, response signal receiving section 265 combines response signals subjected to frequency hopping and repeated two times in one subframe (e.g. by maximum ratio combining). Then, response signal receiving section 265 decides whether or not the response signal indicates an ACK or a NACK, based on the combined signal, and, according to the decision result, outputs an ACK signal or NACK signal to retransmission control section 210.

Control section 270 assigns uplink resources and downlink resources to terminal 100. That is, control section 270 performs scheduling of uplink resources and downlink resources. Then, control section 270 outputs uplink assignment information and downlink assignment information as the scheduling results, to modulating section 205. Also, control section 270 outputs the uplink assignment information (frequency assignment information in this case) to SC-FMA signal demodulating section 250.

Also, control section 270 selects the formation pattern of each uplink subframe between the first pattern in which control channels are placed at both edges of each unit band and in which the control channels placed at both edges of each unit band are switched between slots, and the second pattern in which channel blocks including a plurality of control channels are placed at both edges of an enhancement band formed with a plurality of unit bands and in which the frequency positions of the constituent control channels in each control channel block are switched between slots. Information indicating the selected formation pattern is outputted to broadcast signal generating section 220.

[Operations of Terminal 100 and Base Station 200]

(Broadcast of an Uplink Subframe Formation Pattern)

In control section 270 of base station 200, an uplink subframe formation pattern is selected every subframe between the first pattern in which control channels are placed at both edges of each unit band and in which the control channels placed at both edges of each unit band are switched between slots, and the second pattern in which channel blocks including a plurality of control channels are placed at both edges of an enhancement band formed with a plurality of unit bands and in which the frequency positions of the constituent control channels in each control channel block are switched between slots. That is, base station 200 performs scheduling of subframe formation patterns.

FIG. 5 shows an uplink frame condition based on scheduling of subframe formation patterns in a base station. In FIG. 5, base station 200 selects the first pattern and second pattern alternately. Here, a unit band has a bandwidth of 20 MHz. Also, an enhancement band has a bandwidth of two unit bands, that is, a bandwidth of 40 MHz. That is, the reference bandwidth is 20 MHz in the first pattern and 40 MHz in the second pattern.

Then, information indicating a selected formation pattern is included in broadcast information and broadcasted in broadcast signal generating section 220.

(Subframe Assignment from Base Station 200 to a Terminal)

Basically, base station 200 assigns a second-pattern subframe to terminal 100 that can transmit response signals subjected to space hopping. Also, for example, the first-pattern subframe is assigned to a terminal that cannot transmit response signals with space hopping like an LTE terminal.

With more specific explanation using FIG. 5, a subframe with a reference bandwidth of 40 MHz (i.e. the second subframe in FIG. 5) is assigned to terminal 100. Also, for example, subframes with a reference bandwidth of 20 MHz (i.e. the first and third subframes in FIG. 5) are assigned to an LTE terminal.

Also, base station 200 assigns an uplink subframe in which a formation pattern with a wider reference bandwidth is selected, to a terminal having terminal transmission capability in a wideband. By this means, the assignment target terminal can perform fast transmission of uplink data signals in a PUSCH to which the center frequency domain different from PUCCH's at both edges (in FIG. 5, about 30 MHz continuous frequency band) is assigned.

(Response Signal Transmission Operations in Terminal 100)

In terminal 100, based on uplink assignment information for that terminal transmitted from base station 200 and PUCCH placement information broadcasted from base station 200, control section 140 controls (1) a weighted vector used for precoding, (2) a frequency position on which a response signal is mapped in an SC-FDMA signal and (3) a transmission band.

To be more specific, control section 140 decides whether or not an uplink subframe formation pattern assigned to the subject terminal is the first pattern or the second pattern.

(As a Result of Decision, in the Case of the First Pattern)

(1) If a weighted vector in which all elements are “1” is used in precoding section 178 (i.e. if precoding is not actually performed in precoding section 178), control section 140 may switch weighted vectors used in precoding section 178 between the first slot and the second slot of the same subframe.

(2) In the first slot of the same subframe, control section 140 maps a response signal on one end of the IFFT frequency band in SC-FDMA signal forming section 175 and maps a response signal on the other end in the second slot.

(3) Control section 140 adjusts the transmission band of RF transmission section 185 to a unit band assigned to the subject terminal.

(As a Result of Decision, in the Case of the Second Pattern)

In a case where the second pattern is decided, control section 140 compares the communication-capable bandwidth (i.e. bandwidth determined by terminal capability) of the subject terminal and the reference bandwidth in the second pattern.

(a) As a result of comparison, if the communication-capable bandwidth of the subject terminal is smaller than the reference bandwidth in the second pattern.

(1) Control section 140 switches weighted vectors used in precoding section 178 between the first slot and second slot of the same subframe. Here, the timing of switching weighted vectors is the boundary between the first slot and the second slot.

(2) Control section 140 makes frequency mapping section 177 map a PUCCH signal on a frequency position corresponding to a control channel assigned to the subject terminal, in a channel block placed in one end.

(3) Control section 140 adjusts the transmission band of RF transmission section 185 to one end of the enhancement band in which the control channel assigned to the subject terminal is placed.

FIG. 6 illustrates response signal transmission operations in terminal 100 when the communication-capable bandwidth of that terminal is smaller than the reference bandwidth in the second pattern. Here, especially, terminal 100 having a 20 MHz transmission-capable bandwidth and an IFFT frequency band corresponding to this bandwidth, is assigned to a subframe having a 40 MHz reference bandwidth. In FIG. 6, “RS” stands for a reference signal placed upon transmitting a response signal in a PUCCH, and an ACK represents an SC-FDMA symbol in which a spread response signal is placed.

In FIG. 6, in any of the first slot and second slot included in one subframe, a response signal spread by a spreading code for a normal format is placed in four SC-FDMA symbols.

Here, the response signal is spread in two stages. In the first stage of spreading, response signal spreading section 165 performs spreading such that a response signal of one symbol occupies the whole one SC-FDMA symbol. That is, one SC-FDMA symbol is formed with twelve time-continuous signals, and, consequently, in the first stage of spreading, a spreading code of a sequence length of 12 is used.

Then, in the second stage of spreading, response signal spreading section 165 spreads the response signal having a length corresponding to one SC-FDMA symbol, obtained in the first stage, by a spreading code with a sequence length of 4 (which is one of Walsh codes (1,1,1,1), (1,−1,1,−1), (1,1,−1,−1) and (1,−1,−1,1)). The response signal having a length of four SC-FDMA symbols, obtained as above, is placed in four SC-FDMA symbols in one slot. FIG. 6 shows this placement condition. Also, a response signal from other terminals is spread by a different spreading code. Therefore, by applying despreading in a CDMA technique to a reception response signal, base station 200 on the receiving side can separate the response signal from each terminal.

Frequency mapping section 177 maps a PUCCH signal on a frequency position corresponding to a control channel assigned to the subject terminal, in a channel block placed in one end. FIG. 6 shows a case where PUCCH 1 in FIG. 5 is assigned to terminal 100.

Also, control section 140 adjusts one end of the transmission band of RF transmission section 185 to one end of the enhancement band in which the control channel assigned to the subject terminal is placed.

(b) As a result of comparison, if the reference bandwidth in the second pattern is equal to or smaller than the communication-capable bandwidth of the subject terminal

(1) Control section 140 switches weighted vectors used in precoding section 178 between the first slot and the second slot of the same subframe.

(2) Control section 140 makes frequency mapping section 177 map a PUCCH signal on the frequency position corresponding to a control channel assigned to the subject terminal, in a channel block placed in one end.

(3) Control section 140 adjusts the transmission band of RF transmission section 185 to the enhancement band assigned to the subject terminal. To be more specific, the transmission bandwidth and the bandwidth of the enhancement band match, and, consequently, RF transmission section 185 adjusts the center frequency of the transmission band to the center frequency of the enhancement band.

As described above, according to the present embodiment, in base station 200 that can assign a plurality of unit bands to single communication, control section 270 selects a formation pattern of an uplink subframe formed with two slots, between the first pattern in which control channels are placed at both edges of each unit band and in which the control channels placed at both edges of each unit band are switched between slots, and the second pattern in which channel blocks including a plurality of control channels are placed at both edges of an enhancement band formed with a plurality of unit bands and in which the frequency positions of the constituent control channels in each control channel block are switched between slots. Then, information about a selected formation pattern is transmitted to an assignment target terminal to which an uplink subframe is assigned.

Thus, by providing the second pattern in an uplink subframe, it is possible to prepare a wide frequency domain between control channels. Then, by using the wide frequency domain between control channels as a channel (PUTSCH) used for uplink data transmission and assigning this frequency domain to a terminal that can perform wideband communication, it is possible to realize fast uplink data communication. Especially, by transmitting an SC-FDMA signal in uplink and assigning continuous wide bands to a terminal having a wide transmission band, it is possible to maintain a single carrier characteristic of the SC-FDMA signal (i.e. characteristic of low PAPR), so that it is possible to realize fast uplink data communication by SC-FDMA.

Also, according to the present embodiment, in terminal 100, when pattern information obtained in broadcast signal receiving section 125 indicates the second pattern and the communication-capable bandwidth of that terminal is equal to or larger than the reference bandwidth of the formation pattern corresponding to the pattern information, control section 140 adjusts the transmission band of RF transmission section 185 to an enhancement band and changes weighted vectors used in precoding section 178 between the first slot and the second slot.

Thus, by changing weighted vectors between the first slot and the second slot, the spatial diversity effect is provided. Therefore, by adopting a subframe formation (i.e. the above second pattern) in which frequency hopping with a small hopping width is performed in a channel block placed in one end of the enhancement band, it is possible to compensate for the reduced frequency fading robustness effect by the spatial diversity effect.

Also when pattern information obtained in broadcast signal receiving section 125 indicates the second pattern and the communication-capable bandwidth of the subject terminal is larger than the reference bandwidth of the formation pattern corresponding to the pattern information, control section 140 adjusts the transmission band to one end of the enhancement band to change a weighted vector and a frequency position on which a control channel signal is mapped in a channel block placed at the one end, between the first slot and the second slot.

By this means, it is possible to perform assignment in a subframe having a wider reference bandwidth than the transmission-capable band of the subject terminal (i.e. above second-pattern subframe), and realize terminal 100 that can perform control channel transmission that can provide the frequency fading robustness effect and spatial diversity effect. Therefore, it is possible to assign terminals in a balanced manner to a frame having subframes of different formation patterns together, so that it is possible to realize a communication system with the high frequency use efficiency.

### Embodiment 2

In Embodiment 2, if a terminal is assigned a second-pattern subframe, transmission antennas are switched between slots in the subframe.

[Terminal Configuration]

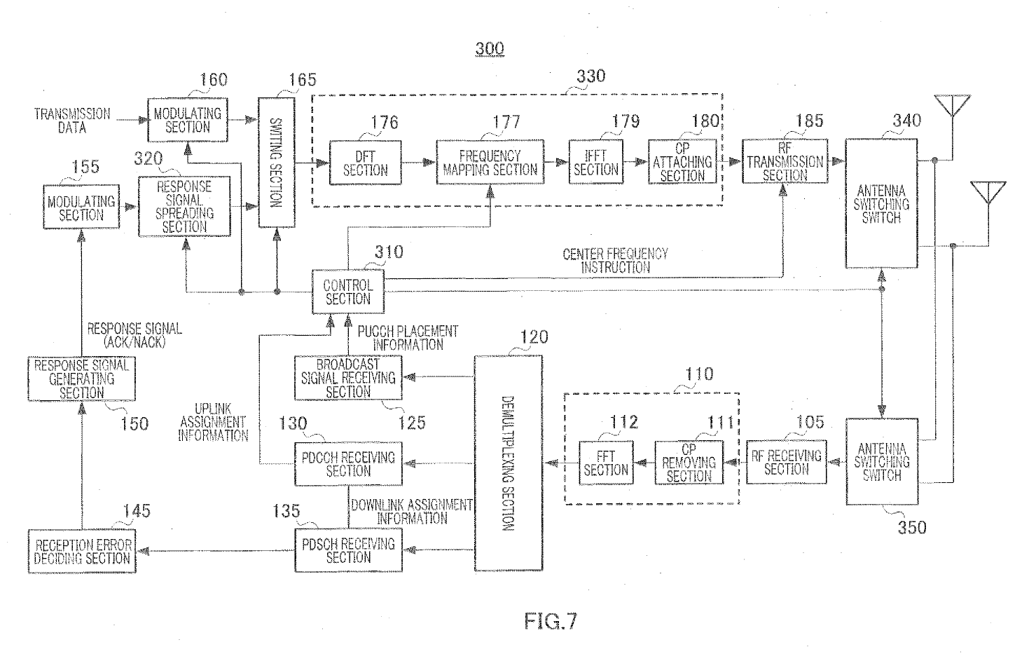

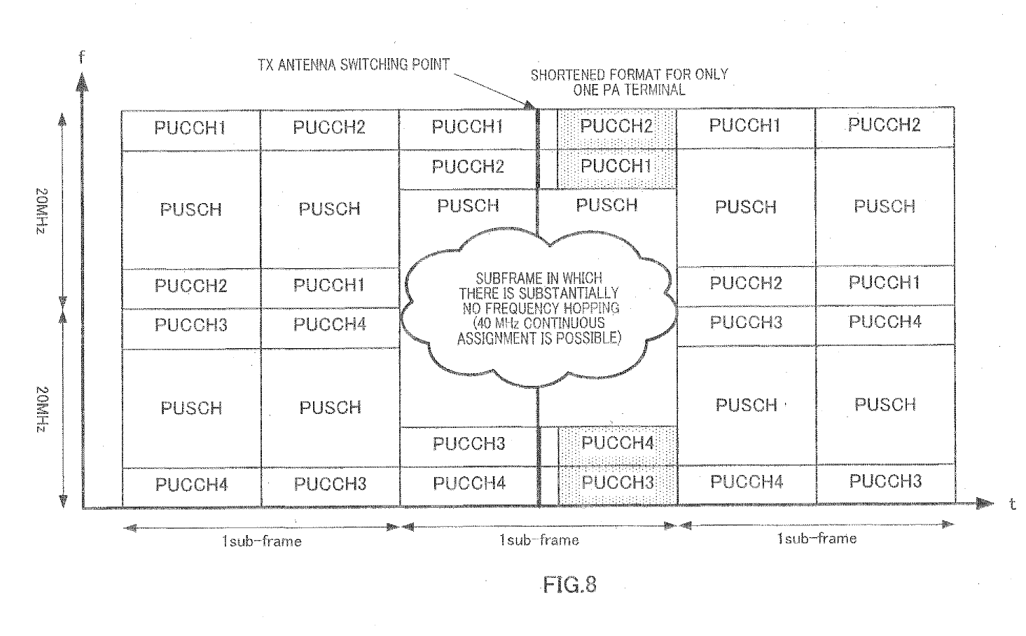

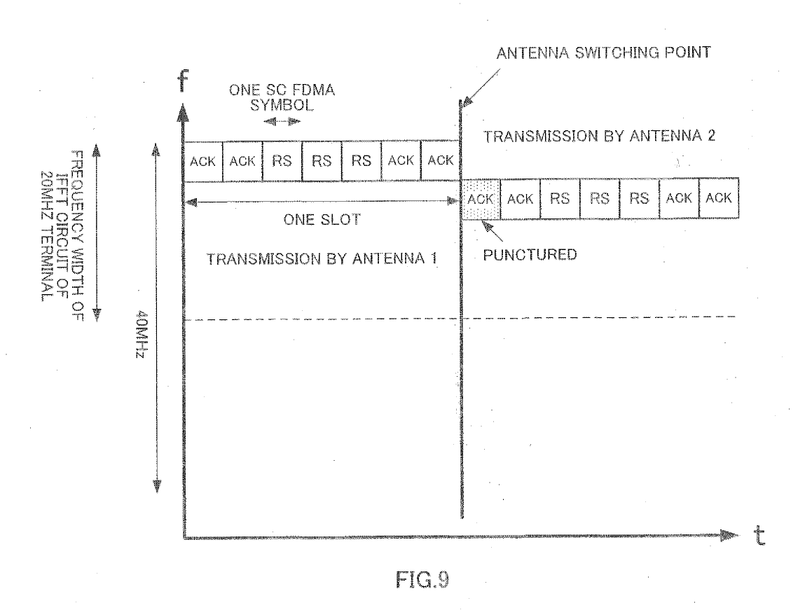

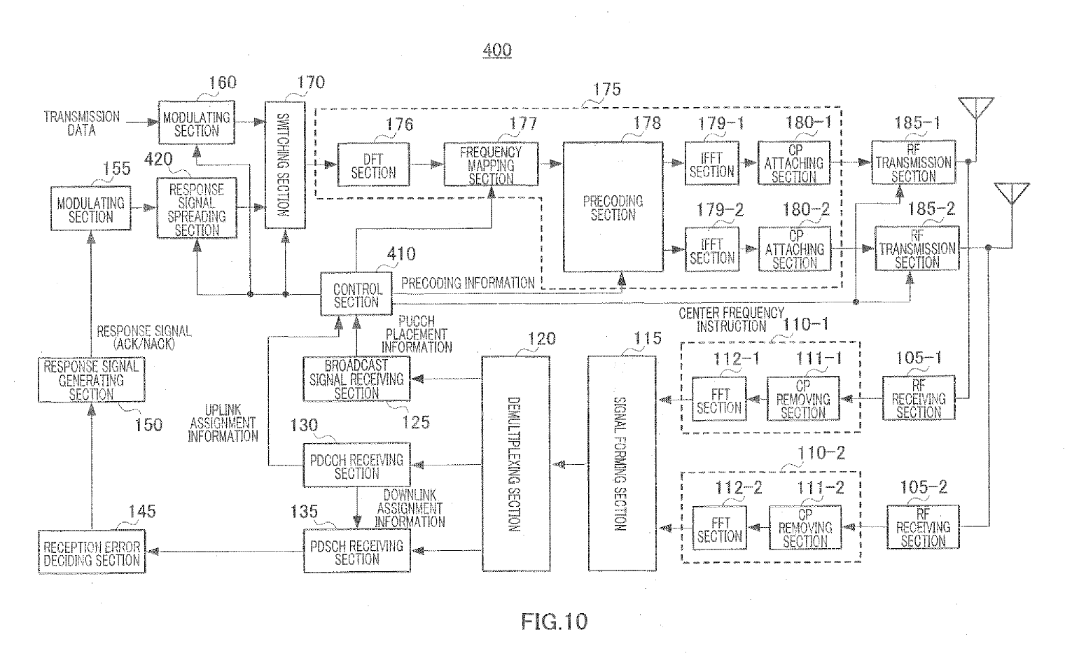

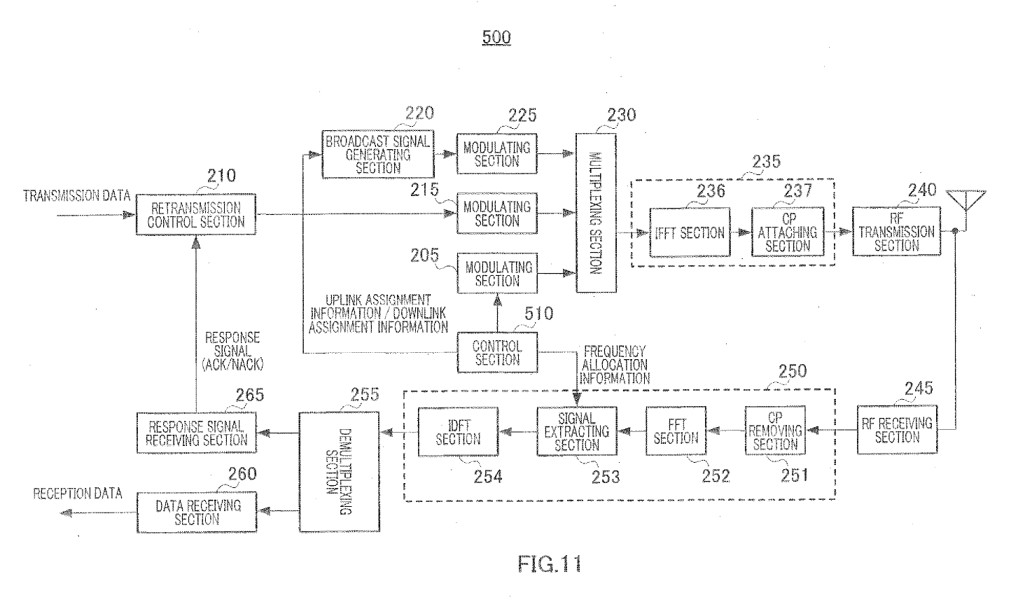

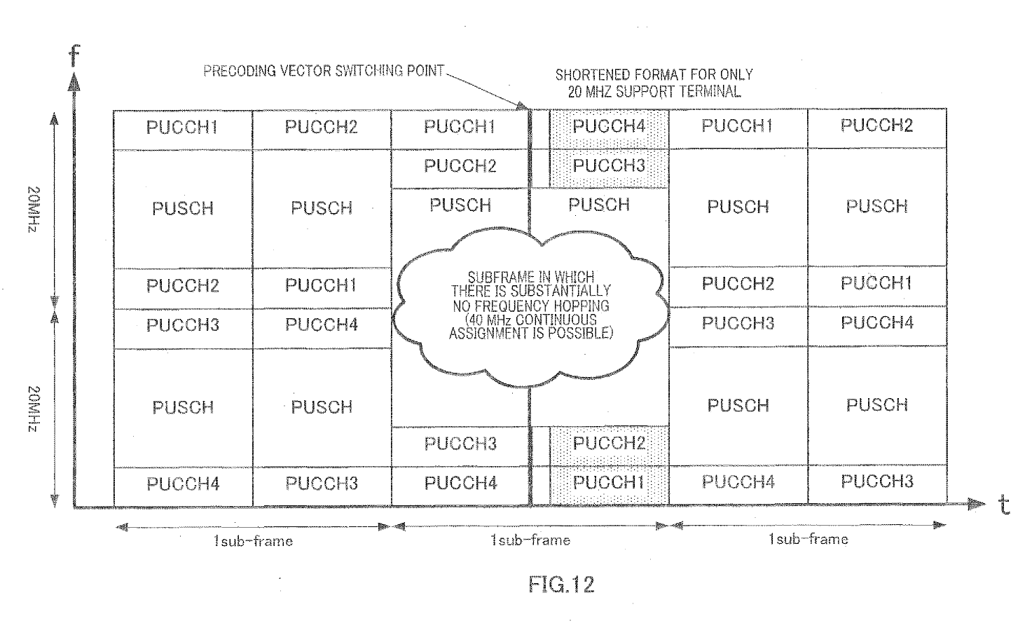

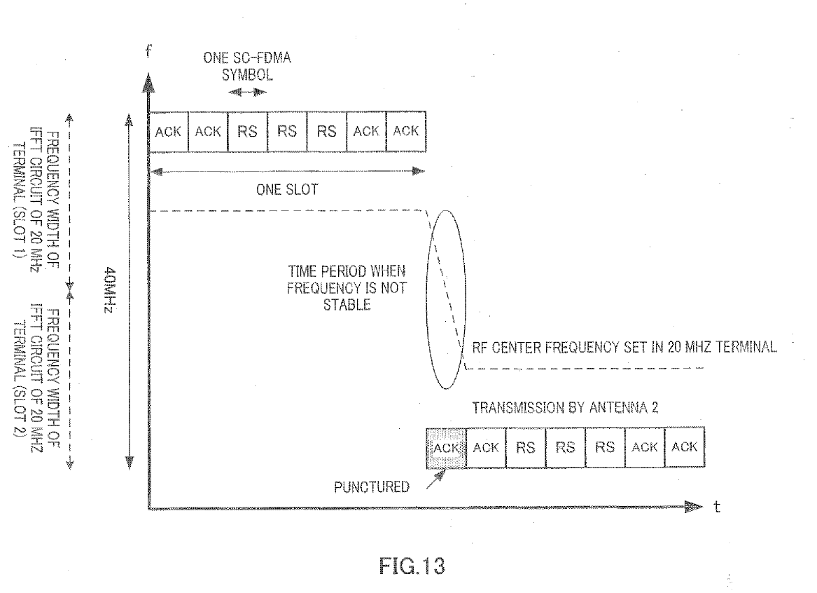

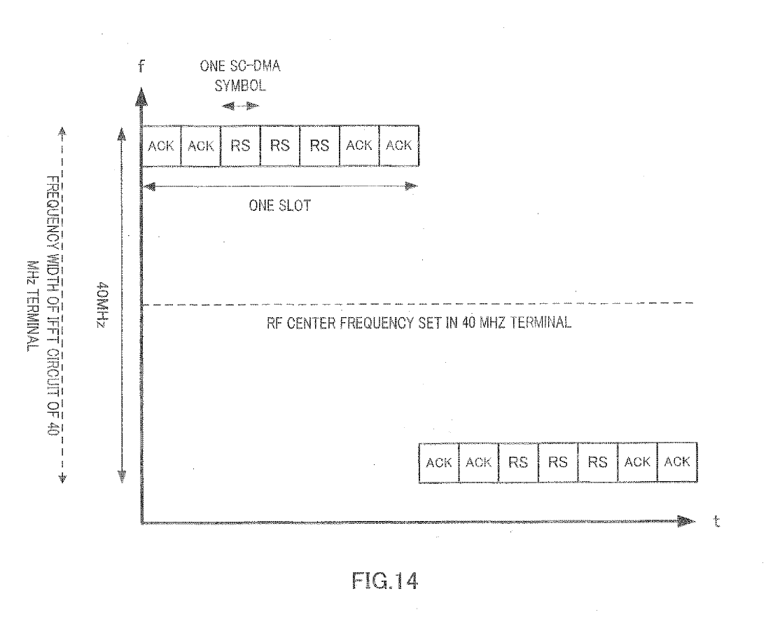

FIG. 7 is a block diagram showing a configuration of terminal 300 according to Embodiment 2 of the present invention. In FIG. 7, terminal 300 is provided with control section 310, response signal spreading section 320, SC-FDMA signal forming section 330, antenna switching switches 340 and 350. Terminal 300 has two antennas. Unlink terminal 100 of Embodiment 1, terminal 300 has one RF transmission section 185 and therefore provides one power amplifier (PA). In addition, terminal 300 limits an input signal for the reception system to a reception signal received via one of those antennas, in antenna switching switch 350. Therefore, unlike terminal 100, terminal 300 does not have signal forming section 1125. In addition, unlike terminal 100, terminal 300 does not have a precoding section in SC-TDMA signal forming section 330.

Control section 310 controls the transmission antennas, the frequency position on which a response signal is mapped in an SC-FDMA signal, a transmission band and a spreading pattern applied to a response signal, based on uplink assignment information received from PDCCH receiving section 130 and PUCCH placement information received from broadcast signal receiving section 125.

To be more specific, control section 310 decides whether an uplink subframe formation pattern assigned to the subject terminal is the first pattern or the second pattern.

Then, control section 310 outputs a mapping control signal for mapping a PUCCH signal (i.e. response signal) on the frequency position based on the uplink subframe formation pattern, to SC-FDMA signal forming section 330. Regarding this response signal mapping, control section 310 and control section 140 have the same function.

If the second pattern is decided, control section 310 switches the transmission antennas between the first slot and the second slot in the same subframe. To be more specific, control section 310 switches the transmission antennas by switching the output destination antenna of antenna switching switch 340 using a transmission antenna switching signal. Thus, it is possible to transmit a response signal subjected to space hopping.

Also, if the second pattern is decided, the communication-capable bandwidth (i.e. bandwidth determined by terminal capability) of the subject terminal and the reference bandwidth in the second pattern are compared.

As a result of comparison, if the reference bandwidth in the second pattern is smaller than the communication-capable bandwidth of the subject terminal or these bandwidths are equal, control section 310 uses a spreading code used in response signal spreading section 320 as a spreading code for a shortened format. At this time, control section 310 adjusts the transmission band of RF transmission section 185 to the enhancement band.

In contrast, as a result of comparison, if the reference bandwidth in the second pattern is smaller than the communication-capable bandwidth of the subject terminal, control section 310 also uses a spreading code used in response signal spreading section 320 as a spreading code for the shortened format. At this time, control section 310 adjusts the transmission band of RF transmission section 185 to one end of the enhancement band in which control channels assigned to the subject terminal are placed. This transmission band adjustment is performed based on a center frequency instruction outputted from control section 140.

[Operations of Terminal 300 and Base Station 200]

(Subframe Assignment from Base Station 200 to a Terminal)

Basically, base station 200 assigns a second-pattern subframe to terminal 300 that can transmit response signals subjected to space hopping.

Also, for example, the first-pattern subframe is assigned to a terminal that cannot transmit response signals subjected to space hopping like an LTE terminal.

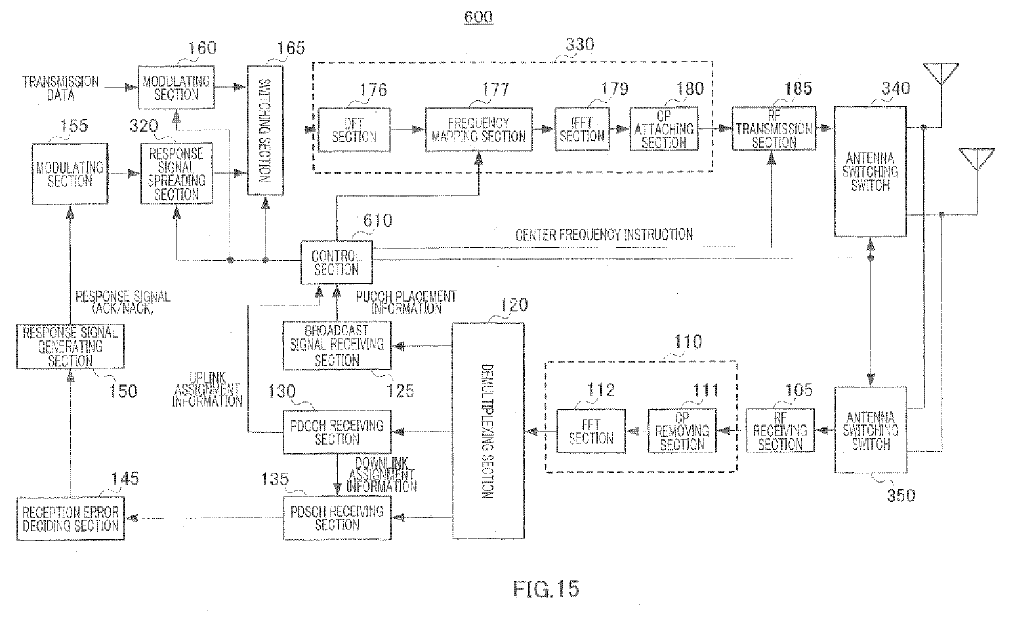

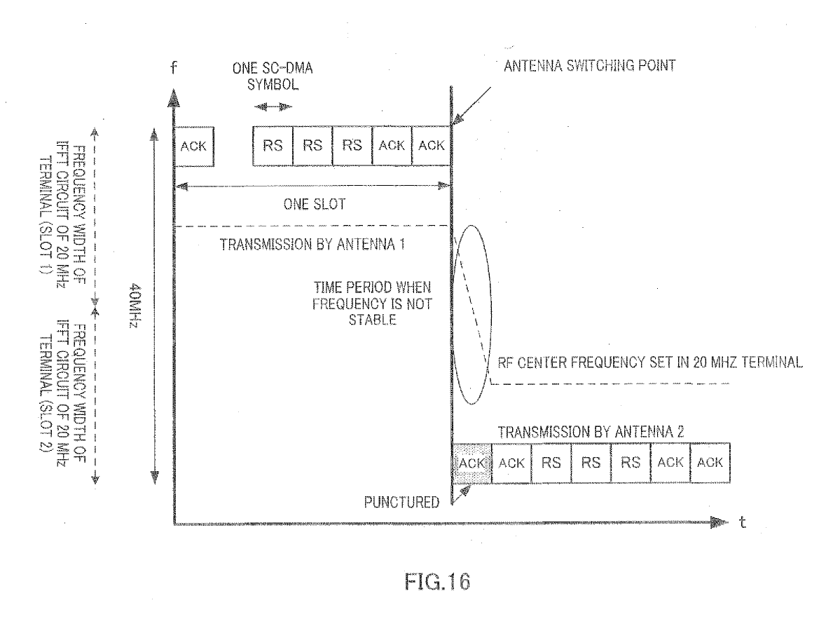

With more specific explanation using FIG. 8, a subframe with a reference bandwidth of 40 MHz (i.e. the second subframe in FIG. 8) is assigned to terminal 300. Also, for example, subframes with a reference bandwidth of 20 MHz (i.e. the first and third subframes in FIG. 8) are assigned to an LTE terminal.

Also, regarding assignment of subframes with a small PUCCH frequency hopping width like a second-pattern subframe to terminal 300, it is equally possible to use the separation distance between terminal 300 that is the assignment target and base station 200. That is, as described later, the shortened format is the format in which only one SC-FDMA symbol of a response signal is punctured, which may cause the degradation in the reception SNR of a PUCCH on the receiving side (i.e. base station 200). Therefore, the reception quality may be already poor when the separation distance with base station 200 is large, and, consequently, it may be possible not to assign an uplink subframe with a small PUCCH frequency hopping width like a second-pattern subframe to terminal 300 having a large separation distance with base station 200. By this means, in the case of a subframe in which a PUCCH frequency hopping width is sufficiently large like the first-pattern subframe, terminal 300 needs not perform space hopping and can use a normal-format PUCCH. Also, the separation distance between terminal 300 and base station 200 may be determined from a position found by GPS. Also, it may be possible to use, for example, the reception power in base station 200 of a pilot signal transmitted from terminal 300, as an indication of the separation distance.

(Response Signal Transmission Operations in Terminal 300)

Regarding control of (2) a frequency position on which a response signal is mapped in an SC-FDMA signal and (3) a transmission band based on uplink assignment information for the subject terminal and PUCCH placement information broadcasted from base station 200, control section 310 performs the same operations as control section 140 of Embodiment 1 (see FIG. 8).

Instead of controlling (1) a weighted vector used for precoding, control section 310 controls (4) transmission antennas and further (5) a spreading pattern applied to a response signal.

To be more specific, control section 310 decides whether the uplink subframe formation pattern assigned to the subject terminal is the first pattern or the second pattern.

(As a Result of Decision, in the Case of the First Pattern)

(2) In the first slot of the same subframe, control section 310 maps a response signal on one end of the IFFT frequency band in SC-FDMA signal forming section 175 and maps a response signal on the other end in the second slot.

(3) Control section 310 adjusts the transmission band of RF transmission section 185 to a unit band assigned to the subject terminal.

(4) Control section 310 may or may not switch the transmission antennas between the first slot and the second slot in the same subframe.

(5) Control section 310 uses a spreading code used in response signal spreading section 320, as a spreading code for a normal format.

(As a Result of Decision, in the Case of the Second Pattern)

In a case where the second pattern is decided, control section 310 compares the communication-capable bandwidth (i.e. bandwidth determined by terminal capability) of the subject terminal and the reference bandwidth in the second pattern.

(a) As a result of comparison, if the communication-capable bandwidth of the subject terminal is smaller than the reference bandwidth in the second pattern

(2) Control section 310 makes frequency mapping section 177 map a PUCCH signal on the frequency position corresponding to a control channel assigned to the subject terminal, in a channel block placed in one end.

(3) Control section 140 adjusts the transmission band of RF transmission section 185 to one end of the enhancement band in which the control channel assigned to the subject terminal is placed.

(4) Unlike control section 140 of Embodiment 1, control section 310 switches the transmission antennas between the first slot and the second slot in the same subframe. That is, by switching the transmission antennas, control section 310 performs space hopping processing in the first slot and second slot of the same subframe. Here, as shown in FIG. 8, the switching timing of transmission antennas is the boundary between the first slot and the second slot.

(5) Control section 310 uses a spreading code used for response signal spreading section 320, as a spreading code for a shortened format.

FIG. 9 illustrates response signal transmission operations in terminal 300 when the communication-capable bandwidth of that terminal is smaller than the reference bandwidth in the second pattern. Here, especially, terminal 300 having a 20 MHz transmission-capable bandwidth and an IFFT frequency band corresponding to this bandwidth, is assigned to a subframe having a 40 MHz reference bandwidth. In FIG. 9, “RS” stands for a reference signal placed upon transmitting a response signal in a PUCCH, and an ACK represents an SC-FDMA symbol in which a spread response signal is placed.

In FIG. 9, in the first slot included in one subframe, a response signal spread by a spreading code for the above-noted normal format is placed in four SC-FDMA symbols. However, in the second slot, a response signal spread by a spreading code for the shortened format is placed in three SC-FDMA symbols excluding the first SC-FDMA symbol in that slot. By this means, transmission signals are not stable for a while after the transmission antennas are switched, but it is possible to prevent unnecessary transmission operations by using the first SC-FDMA symbol in the second slot as a non-transmission period.

Here, the response signal is also spread in two stages in the shortened format. In the first stage of spreading, response signal spreading section 320 performs spreading such that a response signal of one symbol occupies the whole one SC-FDMA symbol. That is, one SC-FDMA symbol is formed with twelve time-continuous signals, and, consequently, in the first stage of spreading, a spreading code of a sequence length of 12 is used.

Then, in the second stage of spreading, response signal spreading section 320 spreads the response signal having the length corresponding to one SC-FDMA symbol, obtained in the first stage, by a spreading code with a sequence length of 3. The spreading code with a sequence length of 3 needs to be an orthogonal sequence because the response signal is subjected to code division multiplexing. Therefore, with the present embodiment, one of (1,1,1), (1,e^{j2p/3}, e^{j4p/3}) and (1,e^{j4p/3}, e^{j2p/3}), which are DFT codes formed by 3×3 DFT matrix elements, is used as a spreading code. The response signal having the length corresponding to three SC-FDMA symbols, obtained as above, is placed in three SC-FDMA symbols in one slot. FIG. 9 shows this placement condition. That is, while a response signal is placed in four SC-FDMA symbols in the first slot, a response signal is punctured in the first SC-FDMA symbol and placed in the rest of the three SC-FDMA symbols.

(b) As a result of comparison, if the reference bandwidth in the second pattern is equal to or smaller than the communication-capable bandwidth of the subject terminal

(2) Control section 310 makes frequency mapping section 177 map a PUCCH signal on the frequency position corresponding to a control channel assigned to the subject terminal, in a channel block placed in one end.

(3) Control section 310 adjusts the transmission band of RF transmission section 185 to the enhancement band assigned to the subject terminal. To be more specific, the transmission bandwidth and the bandwidth of the enhancement band match, and, consequently, RF transmission section 185 adjusts the center frequency of the transmission band to the center frequency of the enhancement band.

(4) Unlike control section 140 of Embodiment 1, control section 310 switches the transmission antennas between the first slot and the second slot in the same subframe. That is, by switching the transmission antennas, control section 310 performs space hopping processing in the first slot and second slot of the same subframe. Here, as shown in FIG. 8, the switching timing of transmission antennas is the boundary between the first slot and the second slot.

(5) Control section 310 uses a spreading code used for response signal spreading section 320, as a spreading code for a shortened format.

Also, according to the present embodiment, in terminal 300, when pattern information obtained in broadcast signal receiving section 125 indicates the second pattern and the communication-capable bandwidth of that terminal is equal to or larger than the reference bandwidth of the formation pattern corresponding to the pattern information, control section 310 adjusts the transmission band of RF transmission section 185 to an enhancement band and changes the output destination antenna of RF transmission section 185 between the first slot and the second slot.

Thus, by changing the transmission antennas between the first slot and the second slot, the spatial diversity effect is provided. Therefore, by adopting a subframe formation (i.e. the above second pattern) in which frequency hopping with a small hopping width is performed in a channel block placed in one end of the enhancement band, it is possible to compensate for the reduced frequency fading robustness effect by the spatial diversity effect.

Also, when pattern information obtained in broadcast signal receiving section 125 indicates the second pattern and the communication-capable bandwidth of the subject terminal is larger than the reference bandwidth of the formation pattern corresponding to the pattern information, control section 310 adjusts the transmission band to one end of the enhancement band to change the output destination antenna of RF transmission section 185 and a frequency position on which a control channel signal is mapped in a channel block placed at the one end, between the first slot and the second slot.

By this means, it is possible to perform assignment in a subframe having a wider reference bandwidth than the transmission-capable band of the subject terminal (i.e. above second-pattern subframe), and realize terminal 100 that can perform control channel transmission that can provide the frequency fading robustness effect and spatial diversity effect. Therefore, it is possible to assign terminals in a balanced manner to a frame having subframes of different formation patterns together, so that it is possible to realize a communication system with the high frequency use efficiency.

Also, in the above explanation, a shortened format is adopted in the second slot to switch transmission antennas in the head SC-FDMA symbol of the second slot. However, it is equally possible to adopt a shortened format in the first slot. In this case, assume that the transmission antennas are switched in the end SC-FDMA symbol of the first slot and this SC-FDMA symbol represents a non-transmission period of response signals.

### Embodiment 3

Embodiment 3 differs from Embodiment 1 in a second-pattern subframe formation. Based on this subframe formation difference, a terminal controls a spreading pattern applied to a response signal.

[Terminal Configuration]

FIG. 10 is a block diagram showing a configuration of terminal 400 according to Embodiment 3 of the present invention. In FIG. 10, terminal 400 has control section 410 and response signal spreading section 420.

Control section 410 controls a weighted vector used for precoding, a frequency position and transmission band on which a response signal is mapped in an SC-FDMA signal, and a spreading pattern applied to a response signal, based on uplink assignment information received from PDCCH receiving section 130 and the PUCCH placement information received from broadcast signal receiving section 125. Here, the PUCCH placement information includes formation pattern information of uplink subframes. The uplink subframe formation pattern includes the first pattern in which control channels are placed at both edges of each unit band and the second pattern in which control channels are placed at both edges of an enhancement band formed with a plurality of unit bands. In the first pattern, the unit bandwidth is a “reference bandwidth,” and, in the second pattern, the enhancement bandwidth is the reference bandwidth.

To be more specific, control section 410 outputs, to SC-TDMA signal forming section 175, a mapping control signal for mapping a PUCCH signal (i.e. response signal) on a frequency position based on the uplink subframe formation pattern. Here, in the case of the above first or second pattern, in the first slot of the same subframe, control section 410 maps a response signal on one end of the IFFT frequency band in SC-FDMA signal forming section 175 and maps a response signal on the other end in the second slot.

Also, control section 410 decides whether the uplink subframe formation pattern assigned to the subject terminal is the first pattern or the second pattern, and, if this formation pattern indicates the second pattern, compares the communication-capable bandwidth (i.e. bandwidth determined by terminal capability) of the subject terminal and the reference bandwidth in the second pattern.

As a result of comparison, if the reference bandwidth in the second pattern is smaller than the communication-capable bandwidth of the subject terminal or these bandwidths are equal, control section 410 uses a spreading code used in response signal spreading section 420 as a spreading code for a normal format. At this time, control section 410 adjusts the transmission band of RF transmission section 185 to the enhancement band and does not move this transmission band.

As a result of comparison, if the communication-capable bandwidth of the subject terminal is smaller than the reference bandwidth in the second pattern, control section 410 uses a spreading code used in response signal spreading section 420 as a spreading code for a shortened format. This spreading code for the shortened format is the same as explained in Embodiment 2. At this time, furthermore, in the same subframe, control section 410 adjusts the transmission band of RF transmission section 185 so as to transmit a response signal in one end of the enhancement band in the first slot and transmit a response signal in the other end in the second slot. This transmission band adjustment is performed based on a center frequency instruction outputted from control section 410.

Response signal spreading section 420 spreads a modulated response signal using a spreading code based on the instruction of control section 410 and outputs the spread response signal to switching section 170.

FIG. 11 is a block diagram showing a configuration of base station 500 according to Embodiment 3 of the present invention. In FIG. 11, base station 500 has control section 510.

Control section 510 selects the formation pattern of each uplink subframe between the first pattern in which control channels are placed at both edges of each unit band and in which the control channels placed at both edges of each unit band are switched between slots, and the second pattern in which control channels are placed at both edges of an enhancement band formed with a plurality of unit bands and in which the control channels placed at both edges of the enhancement band are switched between slots. Information indicating the selected formation pattern is outputted to broadcast signal generating section 220.

[Operations of Terminal 400 and Base Station]

(Broadcast of an Uplink Subframe Formation Pattern)

In control section 510 of base station 500, an uplink subframe formation pattern is selected every subframe between the first pattern in which control channels are placed at both edges of each unit band and in which the control channels placed at both edges of each unit band are switched between slots, and the second pattern in which channel blocks including a plurality of control channels are placed at both edges of an enhancement band formed with a plurality of unit bands and in which the frequency positions of the constituent control channels in each control channel block are switched between slots. That is, base station 500 performs scheduling of subframe formation patterns.

FIG. 12 shows an uplink frame condition based on scheduling of subframe formation patterns in a base station. In FIG. 12, base station 200 selects the first pattern and second pattern alternately. Here, a unit band has a bandwidth of 20 MHz. Also, an enhancement band has a bandwidth of two unit bands, that is, a bandwidth of 40 MHz. That is, the reference bandwidth is 20 MHz in the first pattern and 40 MHz in the second pattern.

Then, information indicating a selected formation pattern is included in broadcast information and broadcasted in broadcast signal generating section 220.

(Subframe Assignment from Base Station 500 to a Terminal)

Basically, base station 500 performs the following subframe assignment according to the terminal capability of a subframe assignment target terminal. That is, base station 500 assigns, to each terminal, an uplink subframe in which a formation pattern providing a reference bandwidth equal to or smaller than the transmission-capable bandwidth of each terminal is selected.

With more specific explanation using FIG. 12, subframes with a reference bandwidth of 20 MHz (i.e. the first and third subframes in FIG. 12) are assigned to a terminal having a transmission-capable bandwidth of 20 MHz. Also, for example, a subframe with a reference bandwidth of 40 MHz (i.e. the second subframe in FIG. 12) is assigned to a terminal having a transmission-capable bandwidth of 40 MHz or above.

However, it may be possible to assign an uplink subframe in which a formation pattern having a wider reference bandwidth than the transmission-capable bandwidth is selected, to terminal 400 that can use the above shortened format and that can change the transmission band. That is, even terminal 400 that has only a transmission-capable bandwidth of 20 MHz may be assigned to the second subframe in FIG. 12. In FIG. 12, shortened-format PUCCH's are shown in the second subframe.

Also, regarding, for terminal 400, assignment of uplink subframes in which a formation pattern having a wider reference bandwidth than the transmission-capable bandwidth is selected, it is equally possible to use the separation distance between terminal 400 that is the assignment target and base station 500. That is, the shortened format is the format in which only one SC-FDMA symbol of a response signal is punctured, which may cause the degradation in the reception SNR of a PUCCH on the receiving side (i.e. base station 500). Therefore, the reception quality may be already poor when the separation distance with base station 500 is large, and, consequently, it may be possible not to assign an uplink subframe in which a formation pattern having a wider reference bandwidth than the transmission-capable bandwidth is selected, to terminal 400 having a large separation distance with base station 500. Also, the separation distance between terminal 400 and base station 500 may be determined from a position found by GPS. Also, it may be possible to use, for example, the reception power in base station 500 of a pilot signal transmitted from terminal 400, as an indication of the separation distance.

Also, base station 500 assigns an uplink subframe in which a formation pattern with a wider reference bandwidth is selected, to a terminal having terminal transmission capability in a wideband. By this means, the assignment target terminal can perform fast transmission of uplink data signals in a PUSCH to which the center frequency domain different from PUCCH's at both edges (in FIG. 12, about 30 MHz continuous frequency band) is assigned.

(Response Signal Transmission Operations in Terminal 400)

In terminal 400, based on uplink assignment information for that terminal transmitted from base station 500 and PUCCH placement information broadcasted from base station 500, control section 410 controls (1) a weighted vector used for precoding, (2) a frequency position on which a response signal is mapped in an SC-FDMA signal, (3) a transmission band and (5) a spreading pattern applied to a response signal.

To be more specific, control section 410 decides whether an uplink subframe formation pattern assigned to the subject terminal is the first pattern or the second pattern.

(As a Result of Decision, in the Case of the Second Pattern)

If the uplink subframe formation pattern assigned to the subject terminal indicates the second pattern, control section 410 compares the communication-capable bandwidth of that terminal and a reference bandwidth in the second pattern.

(a) As a result of comparison, if the communication-capable bandwidth of the subject terminal is smaller than the reference bandwidth in the second pattern

(1) Control section 410 switches weighted vectors used in precoding section 178 between the first slot and the second slot of the same subframe. Here, the timing of switching weighted vectors is the boundary between the first slot and the second slot.

(2) Control section 410 makes a response signal mapped on the frequency position based on the uplink subframe formation pattern.

(3) Control section 410 adjusts the transmission band of RF transmission section 185 so as to transmit a response signal in one end of the enhancement band in the first slot and transmit a response signal in the other end in the second slot.

(5) Control section 410 uses a spreading code used for response signal spreading section 420, as a spreading code for a shortened format.

FIG. 13 illustrates response signal transmission operations in terminal 400 when the communication-capable bandwidth of that terminal is smaller than the reference bandwidth in the second pattern. Here, especially, terminal 400 having a 20 MHz transmission-capable bandwidth and an IFFT frequency band corresponding to this bandwidth, is assigned to a subframe having a 40 MHz reference bandwidth. In FIG. 13, “RS” stands for a reference signal placed upon transmitting a response signal in a PUCCH, and an ACK represents an SC-FDMA symbol in which a spread response signal is placed.

In FIG. 13, in the first slot included in one subframe, a response signal spread by a spreading code for the above-noted normal format is placed in four SC-FDMA symbols. However, in the second slot, a response signal spread by a spreading code for the shortened format is placed in three SC-FDMA symbols excluding the first SC-FDMA symbol in that slot.

Also, the transmission bandwidth and the bandwidth of the enhancement band do not match, and, consequently, control section 410 adjusts the transmission band to one end of the enhancement band in the first slot and adjusts the transmission band to the other end of the enhancement band in the second slot. Thus, by using two slots, terminal 400 can cover the whole enhancement band having a bandwidth over the transmission-capable bandwidth of that terminal.

Here, if the transmission band of RF transmission section 185 is changed, frequency is not stable for a while after the change (i.e. frequency transition period), and, consequently, the transmission operations become unstable. Therefore, as described above, it is possible to prevent unnecessary transmission operations by using the first SC-FDMA symbol in the second slot as a non-transmission period.

Also, frequency mapping section 177 maps a response signal subjected to DFT processing, on the frequency position based on the uplink subframe formation pattern. However, the IFFT frequency bandwidth in IFFT section 179 and the bandwidth of the enhancement band do not match, and, consequently, frequency mapping section 177 maps a response signal subjected to DFT processing, on the IFFT frequency position corresponding to the frequency position based on the uplink subframe formation pattern after the transmission band is adjusted. FIG. 13 shows a case where PUCCH 1 of FIG. 12 is assigned to terminal 400.

(b) As a result of comparison, if the reference bandwidth in the second pattern is equal to or smaller than the communication-capable bandwidth of the subject terminal

(1) Control section 410 switches weighted vectors used in precoding section 178 between the first slot and the second slot of the same subframe. Here, the timing of switching weighted vectors is the boundary between the first slot and the second slot.

(2) Control section 410 makes a response signal mapped on the frequency position based on the uplink subframe formation pattern.

(3) Control section 410 adjusts the transmission band of RF transmission section 185 to the enhancement band and does not move this transmission band. That is, control section 410 matches the center frequency in the transmission band of RF transmission section 185 to the center frequency in the enhancement band assigned by base station 500.

(5) Control section 410 uses a spreading code used in response signal spreading section 420, as a spreading code for a normal format.

FIG. 14 illustrates response signal transmission operations in terminal 400 when the communication-capable bandwidth of that terminal equals to the reference bandwidth in the second pattern. Here, especially, terminal 400 having a 40 MHz transmission-capable bandwidth and an IFFT frequency band corresponding to this bandwidth, is assigned to a subframe having a 40 MHz reference bandwidth. In FIG. 14, “RS” stands for a reference signal placed upon transmitting a response signal in a PUCCH, and an ACK represents an SC-FDMA symbol in which a spread response signal is placed.

In FIG. 14, in any of the first slot and second slot included in one subframe, a response signal spread by a spreading code for a normal format is placed in four SC-FDMA symbols.

Also, the IFFT frequency bandwidth in IFFT section 179 and the bandwidth of the enhancement band do not match, and, consequently, frequency mapping section 177 maps a response signal subjected to DFT processing, on the IFFT frequency position based on the uplink subframe formation pattern. FIG. 14 shows a case where PUCCH 1 of FIG. 12 is assigned to terminal 400.

Also, the transmission bandwidth and the bandwidth of the enhancement band match, and, consequently, RF transmission section 185 adjusts the center frequency of the transmission band to the center frequency of the enhancement band and does not move these.

Thus, according to the present embodiment, in base station 500 that can assign a plurality of unit bands to single communication, control section 510 selects a formation pattern of an uplink subframe formed with two slots, between the first pattern in which control channels are placed at both edges of each unit band and in which the control channels placed at both edges of each unit band are switched between slots, and the second pattern in which control channels are placed at both edges of an enhancement band formed with a plurality of unit bands and in which the control channels placed at both edges of the enhancement band are switched between slots. Then, information about a selected formation pattern is transmitted to an assignment target terminal to which an uplink subframe is assigned.

Thus, by providing the second pattern in an uplink subframe, it is possible to prepare a wide frequency domain between control channels. Then, by using the wide frequency domain between control channels as a channel (PUSCH) used for uplink data transmission and assigning this frequency domain to a terminal that can perform wideband communication, it is possible to realize fast uplink data communication. Especially, by transmitting an SC-FDMA signal in uplink and assigning continuous wide bands to a terminal having a wide transmission band, it is possible to maintain a single carrier characteristic of the SC-FDMA signal (i.e. characteristic of low PAPR), so that it is possible to realize fast uplink data communication by SC-FDMA.

Also, according to the present embodiment, in terminal 400, when pattern information obtained in broadcast signal receiving section 125 indicates the second pattern and the communication-capable bandwidth of that terminal is larger than the reference bandwidth of the formation pattern corresponding to the pattern information, control section 410 changes weighted vectors used in precoding section 178 between the first slot and the second slot, while adjusting the transmission band of RF transmission section 185 to one end of an enhancement band in the first slot and moving the transmission band to the other end of the enhancement band in the second slot.

By this means, even if a subframe having a wider reference bandwidth than the transmission-capable band of the subject terminal is assigned, by moving the transmission band between slots, it is possible to realize terminal 400 that can cover the whole reference bandwidth. In other words, it is possible to realize terminal 400 that can perform assignment in a subframe in which control channels request frequency hopping in a wider band than the transmission-capable band of the subject terminal. Therefore, it is possible to assign terminals in a balanced manner to a frame having subframes of different formation patterns together, so that it is possible to realize a communication system with the high frequency use efficiency. Further, by this means, it is possible to provide the spatial diversity effect in addition to the effect of improving frequency fading robustness by frequency hopping, so that it is possible to further improve the communication quality of uplink control channels.

### Embodiment 4

In Embodiment 4, similar to Embodiment 2, space hopping is realized by switching transmission antennas. Further, in Embodiment 4, the same subframe formation as in Embodiment 3 is used. That is, a base station according to the present embodiment is base station 500 of Embodiment 3.

FIG. 15 is a block diagram showing a configuration of terminal 600 according to Embodiment 4 of the present invention. In FIG. 15, terminal 600 has control section 610.

Control section 610 controls the transmission antennas, the frequency position on which a response signal is mapped in an SC-FDMA signal, a transmission band and a spreading pattern applied to a response signal, based on uplink assignment information received from PDCCH receiving section 130 and PUCCH placement information received from broadcast signal receiving section 125.

To be more specific, control section 610 outputs a mapping control signal for mapping a PUCCH signal (i.e. response signal) on the frequency position based on the uplink subframe formation pattern, to SC-FDMA signal forming section 330. Here, in either the first pattern or the second pattern, in the same subframe, control section 610 maps a response signal on one end of the IFFT frequency band in SC-FDMA signal forming section 330 and maps a response signal in the other end in the second slot. Control section 610 decides whether an uplink subframe formation pattern assigned to the subject terminal is the first pattern or the second pattern.

Then, control section 610 outputs a mapping control signal for mapping a PUCCH signal (i.e. response signal) on the frequency position based on the uplink subframe formation pattern, to SC-FDMA signal forming section 330. Regarding this response signal mapping, control section 610 and control section 410 have the same function.

If the second pattern is decided, control section 610 switches the transmission antennas between the first slot and the second slot in the same subframe. To be more specific, control section 610 switches the transmission antennas by switching the output destination antenna of antenna switching switch 340 using a transmission antenna switching signal. Thus, it is possible to transmit a response signal subjected to space hopping.

Also, if the second pattern is decided, control section 610 compares the communication-capable bandwidth (i.e. bandwidth determined by terminal capability) of the subject terminal and the reference bandwidth in the second pattern.

As a result of comparison, if the reference bandwidth in the second pattern is smaller than the communication-capable bandwidth of the subject terminal or these bandwidths are equal, control section 610 uses a spreading code used in response signal spreading section 320 as a spreading code for a shortened format. This spreading code for the shortened format is the same as explained in Embodiment 2. At this time, control section 610 adjusts the transmission band of RF transmission section 185 to the enhancement band and does not move this transmission band.

In contrast, as a result of comparison, if the communication-capable bandwidth of the subject terminal is smaller than the reference bandwidth in the second pattern, control section 610 also uses a spreading code used in response signal spreading section 320 as a spreading code for the shortened format. At this time, furthermore, in the same subframe, control section 610 adjusts the transmission band of RF transmission section 185 so as to transmit a response signal in one end of the enhancement band in the first slot and transmit a response signal in the other end in the second slot. This transmission band adjustment is performed based on a center frequency instruction outputted from control section 610.

[Operations of Terminal 600 and Base Station 500]

Broadcasting of an uplink subframe formation pattern and subframe assignment from base station 500 to a terminal, are the same as in Embodiment 3.

(Response Signal Transmission Operations in Terminal 600)

In terminal 600, based on uplink assignment information for that terminal transmitted from base station 500 and PUCCH placement information broadcasted from base station 500, control section 610 controls (2) a frequency position on which a response signal is mapped in an SC-FDMA signal, (3) a transmission band, (4) transmission antennas and (5) a spreading pattern applied to a response signal.

To be more specific, control section 610 decides whether an uplink subframe formation pattern assigned to the subject terminal is the first pattern or the second pattern.

(As a Result of Decision, in the Case of the Second Pattern)

If the uplink subframe formation pattern assigned to the subject terminal indicates the second pattern, control section 610 compares the communication-capable bandwidth of that terminal and a reference bandwidth in the second pattern.

(a) As a result of comparison, if the communication-capable bandwidth of the subject terminal is smaller than the reference bandwidth in the second pattern

(2) Control section 610 makes a response signal mapped on the frequency position based on the uplink subframe formation pattern.

(3) Control section 610 adjusts the transmission band of RF transmission section 185 so as to transmit a response signal in one end of the enhancement band in the first slot and transmit a response signal in the other end in the second slot.

(4) Control section 610 switches the transmission antennas between the first slot and the second slot in the same subframe.

(5) Control section 610 uses a spreading code used for response signal spreading section 320, as a spreading code for a shortened format.

FIG. 16 illustrates response signal transmission operations in terminal 600 when the communication-capable bandwidth of that terminal is smaller than the reference bandwidth in the second pattern. Here, especially, terminal 600 having a 20 MHz transmission-capable bandwidth and an IFFT frequency band corresponding to this bandwidth, is assigned to a subframe having a 40 MHz reference bandwidth. In FIG. 16, “RS” stands for a reference signal placed upon transmitting a response signal in a PUCCH, and an ACK represents an SC-FDMA symbol in which a spread response signal is placed.

In FIG. 16, in the first slot included in one subframe, a response signal spread by a spreading code for the above-noted normal format is placed in four SC-FDMA symbols. However, in the second slot, a response signal spread by a spreading code for the shortened format is placed in three SC-FDMA symbols excluding the first SC-FDMA symbol in that slot.

Also, the transmission bandwidth and the bandwidth of the enhancement band do not match, and, consequently, control section 610 adjusts the transmission band to one end of the enhancement band in the first slot and adjusts the transmission band to the other end of the enhancement band in the second slot. Thus, by using two slots, terminal 600 can cover the whole enhancement band having a bandwidth over the transmission-capable bandwidth of that terminal.

Here, if the transmission band of RF transmission section 185 is changed, frequency is not stable for a while after the change (i.e. frequency transition period), and, consequently, the transmission operations become unstable. Also, transmission signals are not stable for a while after the transmission antennas are switched. Therefore, as described above, it is possible to prevent unnecessary transmission operations by using the first SC-FDMA symbol in the second slot as a non-transmission period.

Also, frequency mapping section 177 maps a response signal subjected to DFT processing, on the frequency position based on the uplink subframe formation pattern. However, the IFFT frequency bandwidth in IFFT section 179 and the bandwidth of the enhancement band do not match, and, consequently, frequency mapping section 177 maps a response signal subjected to DFT processing, on the IFFT frequency position corresponding to the frequency position based on the uplink subframe formation pattern after the transmission band is adjusted. FIG. 16 shows a case where PUCCH 1 of FIG. 12 is assigned to terminal 600.

(b) As a result of comparison, if the reference bandwidth in the second pattern is equal to or smaller than the communication-capable bandwidth of the subject terminal

(2) Control section 610 makes a response signal mapped on the frequency position based on the uplink subframe formation pattern.

(3) Control section 610 adjusts the transmission band of RF transmission section 185 to the enhancement band and does not move this transmission band. That is, control section 610 matches the center frequency in the transmission band of RF transmission section 185 to the center frequency in the enhancement band assigned by base station 500.

(4) Control section 610 switches the transmission antennas between the first slot and the second slot in the same subframe.

(5) Control section 610 uses a spreading code used in response signal spreading section 320, as a spreading code for a shortened format.

As described above, according to the present embodiment, in terminal 600, when pattern information obtained in broadcast signal receiving section 125 indicates the second pattern and the communication-capable bandwidth of that terminal is larger than the reference bandwidth of the formation pattern corresponding to the pattern information, control section 610 changes the output destination antenna of RF transmission section 185 between the first slot and the second slot, while adjusting the transmission band of RF transmission section 185 to one end of an enhancement band in the first slot and moving the transmission band to the other end of the enhancement band in the second slot.

By this means, it is possible to provide the spatial diversity effect in addition to the effect of improving frequency fading robustness by frequency hopping, so that it is possible to further improve the communication quality of uplink control channels.

Also, cases have been described with the above explanation, where, if the reference bandwidth in the second pattern is smaller than the communication-capable bandwidth of the subject terminal or these bandwidths are equal as a result of comparison, terminal 600 changes the transmission antennas between the first slot and the second slot. However, if the reference bandwidth in the second pattern is smaller than the communication-capable bandwidth of the subject terminal or these bandwidths are equal as a result of comparison, terminal 600 may employ a configuration for using only one antenna without switching the transmission antennas. In this case, a normal format is adopted in the second slot.

### Other Embodiment

(1) A case has bee described with Embodiment 1 where, if the reference bandwidth in the second pattern is smaller than the communication-capable bandwidth of the subject terminal or these bandwidths are equal as a result of comparison, terminal 100 transmits a response signal in a normal format. However, terminal 100 may be designed to transmit a response signal in the shortened format explained in Embodiment 2. By this means, for example, in a system including terminal 300 of Embodiment 2 and terminal 100 together, it is possible to orthogonalize response signals transmitted from these terminals.

(2) Example cases have been described above with Embodiments 1 to 4 where a PUCCH signal is a response signal to downlink data. However, the PUCCH signal is not limited to this. For example, even if the PUCCH signal is CQI (Channel Quality Indicator) indicating downlink channel quality, RI (Rank Indicator) indicating the rank number of a downlink channel matrix, or SR (Scheduling Request) to report to a base station that transmission data occurs on the terminal side, the present invention is equally applicable.

(3) Although precoding section 178 is placed before IFFT section 179 in Embodiments 1 to 3, the placement of the precoding section is not limited to this. For example, it is equally possible to place one IFFT section for a signal outputted from frequency mapping section 177 and place a precoding section immediately after the IFFT section. Also, a precoding section may be placed after CP attaching section 180. Further, it is equally possible to employ a configuration placing a precoding section before DFT section 176 and providing a plurality of DFT sections 176 and frequency mapping sections 177.

(4) Although example cases have been described above with Embodiments 1 to 4 where the present invention is implemented with hardware, the present invention can be implemented with software.

Furthermore, each function block employed in the description of each of Embodiments 1 to 4 may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be regenerated is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-205642, filed on Aug. 8, 2008, including the specification, drawings and abstract, is incorporated herein by reference in its entirety.

### INDUSTRIAL APPLICABILITY

The base station and terminal of the present invention are effective to realize uplink data communication in a wideband while realizing a method of placing control channels in a frame, which can be used by terminals having various terminal capabilities.

1. A base station that assigns a plurality of unit bands to single communication, the base station comprising:
a selecting section that selects a formation pattern of an uplink subframe formed with two slots, between a first pattern in which control channels are placed at both edges of each unit band and are switched between slots, and a second pattern in which channel blocks including a plurality of control channels are placed at both edges of an enhancement band formed with a plurality of unit bands and in which frequency positions of constituent control channels in each channel block are switched between slots; and
a transmission section that transmits information related to the selected formation pattern to an assignment target terminal to which the uplink subframe is assigned.

2. A terminal that transmits a single carrier-frequency division multiple access (SC-FDMA) symbol in an uplink subframe which is assigned by a base station that can assign a plurality of unit bands to single communication and which is formed with two slots, the terminal comprising:
an obtaining section that obtains pattern information indicating whether a formation pattern of the assigned uplink subframe is a first pattern in which control channels are placed at both edges of each unit band and are switched between slots, or the formation pattern is a second pattern in which channel blocks including a plurality of control channels are placed at both edges of an enhancement band formed with a plurality of unit bands and in which frequency positions of constituent control channels in each control channel block are switched between slots;
a transmission section that transmits the SC-FDMA symbol and is configure to be able to change a transmission band;
a forming section that forms the SC-FDMA symbol, and that comprises:
a mapping section that maps a control channel signal on a frequency position based on the obtained pattern information in the SC-FDMA symbol; and
a precoding section that performs precoding of a signal obtained in the mapping section with a weight vector; and
a control section that, when the obtained pattern information indicates the second pattern and a reference bandwidth in a formation pattern based on the obtained pattern information is larger than communication-capable bandwidth of the terminal, matches the transmission band to one edge of the enhancement band and changes the weight vector and a frequency position, on which the control channel signal is mapped in a channel block placed at the one edge, between a first slot and a second slot.

3. A terminal that transmits a single carrier-frequency division multiple access (SC-FDMA) symbol in an uplink subframe which is assigned by a base station that can assign a plurality of unit bands to single communication and which is formed with two slots, the terminal comprising:
an obtaining section that obtains pattern information indicating whether a formation pattern of the assigned uplink subframe is a first pattern in which control channels are placed at both edges of each unit band and are switched between slots, or the formation pattern is a second pattern in which channel blocks including a plurality of control channels are placed at both edges of an enhancement band formed with a plurality of unit bands and in which frequency positions of constituent control channels in each control channel block are switched between slots;
a transmission section that transmits the SC-FDMA symbol and is configure to be able to change a transmission band;
a forming section that forms the SC-FDMA symbol, and that comprises:
a mapping section that maps a control channel signal on a frequency position based on the obtained pattern information in the SC-FDMA symbol; and
a precoding section that performs precoding of a signal obtained in the mapping section with a weight vector; and
a control section that, when the obtained pattern information indicates the second pattern and a reference bandwidth in a formation pattern based on the obtained pattern information is larger than a communication-capable bandwidth of the terminal, matches the transmission band to one edge of the enhancement band and changes an output destination antenna of the transmission section and a frequency position, on which the control channel signal is mapped in a channel block placed at the one end, between a first slot and a second slot.

4. The terminal according to claim 3, wherein the control section allocates the control channel signal into an SC-FDMA symbol other than a first SC-FDMA symbol in an SC-FDMA symbol group forming the second slot.
